(19) United States
(12) Patent Application Publication
(10) Pub. No.: US 2012/0323350 A1
(43) Pub. Date: Dec. 20, 2012

(54) SUPPORT SYSTEM FOR SETTING EQUIPMENT PARAMETERS

(76) Inventors: Minoru Yamamoto, Meguro-ku (JP); Tatsushi Imori, Meguro-ku (JP); Shinobu Hirano, Meguro-ku (JP)

(21) Appl. No.: 13/055,334

(22) PCT Filed: Jun. 16, 2010
(86) PCT No.: PCT/JP2010/060167

§ 371 Date: Mar. 16, 2011

(51) Int. Cl. G05B 19/18

(52) U.S. Cl. 700/97

(57) ABSTRACT

An object is to provide an equipment parameter setting support system for supporting the setting of parameters in various processing equipment. The equipment parameter setting support system has an execution results acquisition unit for acquiring, from an equipment controller or EES of the equipment design and manufacturing support system, execution results of a real equipment at any two points in time; a parameter calculation unit for calculating PID parameters at each time point on the basis of the acquired execution results; a difference calculation unit for calculating the difference between the calculated PID parameters; and a variation value calculation unit for calculating a variation value for a unit interval in relation to the calculated difference, wherein, in the equipment design and manufacturing support system, the calculated variation value and a PID parameters stored in the equipment simulator are computed to calculate a new PID parameter, and PID control is executed in the equipment simulator using the new PID parameter.

### TECHNICAL FIELD

The present invention relates to an equipment parameter setting support system for supporting the setting of parameters of various processing equipment.

### BACKGROUND ART

Automatic control is widely used in the steps for manufacturing semiconductor manufacturing equipment, flat panel display manufacturing equipment, solar-cell manufacturing equipment, micro electromechanical systems (MEMS) manufacturing equipment, automated biological analysis equipment, pharmaceutical-products manufacturing equipment, foodstuffs manufacturing equipment, and various other equipment (hereinafter referred to in the present specification merely as “processing equipment,” and in addition to manufacturing equipment and analysis equipment, this includes equipment for carrying out various processing.)

PID control is very often used as the control method in processing equipment that performs automatic control. Accordingly, the parameters for PID control must be suitably set in order to improve and stabilize the performance of the processing equipment. Examples of equipment performance include throughput and speed, as well as suitable processing stably carried out in accordance with established processing conditions (referred to as “recipe” in the present specification).

The methods described in Patent Documents 1 and 2 noted below are used for optimally setting PID parameters for PID control in order to improve and stabilize equipment performance of the processing equipment.

There are schemes other than PID control that are used as the control scheme for automated control. In such cases, automated control is achieved using some form of parameters. Similar to the PID control scheme described above, the parameters used in automated control must be suitably set in order to improve and stabilize the equipment performance of a processing equipment.

The automated control described above has an established recipe and processing is carried out in accordance with the established recipe.

Accordingly, if the recipe used as the basis for automated control is not set by an engineer, the equipment will not function, and the manner in which the recipe is set is very important because the performance of the equipment varies depending on how the recipe is set.

Conventionally, an engineer sets the recipe by setting the data of the recipe as default values, operating real processing equipment in accordance with the recipe and confirming the throughput, thereafter correcting the data of the recipe, then operating the real processing equipment again using the corrected recipe data, and repeating the foregoing steps to set the ultimate recipe. Therefore, setting the data (parameters) in the recipe is important for improving and stabilizing equipment performance.
Patent Document 1: Japanese Laid-open Patent Application No. 2009-199221
Patent Document 2: Japanese Laid-open Patent Application No. 2010-49392

### DISCLOSURE OF THE INVENTION

### Problems to be Solved by the Invention

The parameters used in PID control can be set to ideal PID parameters (PID parameters in an ideal state) by using the methods of the patent documents described above.

However, when the real processing equipment is operated, the ideal state is lost with the passage of time due to degradation of components constituting the processing equipment, the accumulation of unwanted matter, and other causes. The ideal state can be restored by performing maintenance on the components of the processing equipment, but maintenance cannot be carried out frequently. Therefore, throughput is reduced or equipment performance is otherwise reduced and becomes unstable with the passage of time. On the other hand, simulation processing of the processing equipment can be reproduced by using an equipment simulator, but degradation of the components of the processing equipment, accumulation of unwanted matter, and other problems do not occur using simulation processing; and output is constantly obtained with the equipment performance (ideal throughput) in an ideal state. There is a problem in such a case in that there will be a discrepancy between the equipment performance in the real processing equipment and the equipment performance in the equipment simulator (e.g., the throughput in real processing equipment and the throughput in the equipment simulator), and high-precision simulation cannot be carried out. In other words, with conventional simulation processing, there is a problem in that simulation cannot be carried out with consideration given to changes over time in the same manner as real equipment. The same problem occurs when the state of the equipment changes due to equipment trouble or the like. These problems similarly occur in the case of parameters used in automated control other than the PID control scheme.

In the case of a conventional method for setting recipe data, throughput is confirmed by directly operating the real processing equipment on the basis of the recipe envisioned by the engineer. Therefore, when the recipe is to be set, manufacture of the product in a real processing equipment operating in a factory must be temporarily stopped and then operated in order to test the recipe settings. The recipe setting test is usually not completed in a single attempt, and in many cases, a plurality of attempts is required. Therefore, there is a problem in that processing equipment cannot be used for manufacturing products while the recipe-setting test is being carried out, resulting in an obstacle to product manufacture. Also, there is a loss of time because it is necessary to stop the real processing equipment to carry out the test.

### Means Used to Solve the Above-Mentioned Problems

In view of the above, the present inventors firstly invented an equipment parameter setting support system for obtaining suitable parameters in an automated control (PID parameters in a PID control scheme or the parameters of another automated control scheme) with consideration given to change over time and changes in the state of the equipment.

The present inventors secondly invented an equipment parameter setting support system that can set a suitable recipe without operating the real processing equipment to the extent possible in relation to setting a recipe for operating equipment.

The invention according to a first aspect is an equipment parameter setting support system used in an equipment design and manufacturing support system for supporting the design and manufacture of processing equipment, the equipment parameter setting support system having an execution results acquisition unit for acquiring, from an equipment controller or EES of the equipment design and manufacturing support system, execution results of a real equipment at any two points in time; a parameter calculation unit for calculating PID parameters at each time point on the basis of the acquired execution results; a difference calculation unit for calculating the difference between the calculated PID parameters; and a variation value calculation unit for calculating a variation value for a unit interval in relation to the calculated difference, wherein in the equipment design and manufacturing support system, the calculated variation value and PID parameters stored in the equipment simulator are computed to calculate a new PID parameter, and PID control is executed in the equipment simulator using the new PID parameter.

The variation value of the PID parameters used in simulation processing in an equipment simulator can be calculated using the configuration of the present invention. Changes in the equipment state and changes over time that occur in the real equipment can also be reflected in the equipment simulator by presenting a variation value to the equipment simulator and including the variation value in the PID parameter.

The invention according to a second aspect is an equipment parameter setting support system used in an equipment design and manufacturing support system for supporting the design and manufacture of processing equipment, the equipment parameter setting support system having an execution results acquisition unit for acquiring, from an equipment controller or EES of the equipment design and manufacturing support system, execution results of a real equipment at any two points in time; a parameter calculation unit for calculating PID parameters at each time point on the basis of the acquired execution results; a waveform calculation unit for calculating a PID waveform on the basis of the calculated PID parameters; a waveform comparison unit for comparing the calculated PID waveforms; and a variation value calculation unit for calculating a variation value for a unit interval in relation to the variation value at the two points in time in the case that the results of the comparisons satisfy a predetermined condition, wherein in the equipment design and manufacturing support system, the calculated variation value and PID parameters stored in the equipment simulator are computed to calculate a new PID parameter, and PID control is executed in the equipment simulator using the new PID parameter.

The variation value of the PID parameters used in simulation processing in an equipment simulator can be calculated using the configuration of the present invention. Changes in the equipment state and changes over time that occur in the real equipment can also be reflected in the equipment simulator by presenting a variation value to the equipment simulator and including the variation value in the PID parameter.

In the aspects described above, the equipment parameter setting support system may be configured so that the data transmission unit presents the variation value of the calculated PID parameters to the equipment simulator at each arrival of the unit interval; and the equipment design and manufacturing support system cause the variation value to be computed with the PID parameters stored in the equipment simulator to calculate a new PID parameter, and PID control to be executed in the equipment simulator using the new PID parameter.

In the aspects described above, the equipment parameter setting support system may be configured so that the data transmission unit presents the variation value of the calculated PID parameters to the equipment simulator; and the equipment design and manufacturing support system cause the variation value to be computed with the PID parameters stored in the equipment simulator at each arrival of the unit interval to calculate a new PID parameter, and PID control to be executed in the equipment simulator using the new PID parameter.

The variation value of the calculated PID parameters may be transferred to the equipment simulator at each arrival of the unit interval, and may be transferred at the time of calculation and automatically computed by the equipment simulator at each arrival of the unit interval

In the aspects described above, the equipment parameter setting support system may be configured so that the parameter setting system receives input of the PID parameters for simulating an error in the equipment simulator, and presents to the equipment simulator the PID parameters thus received as the input; and the equipment simulator simulates equipment trouble by executing simulation processing on the basis of the PID parameter.

The parameter setting system ordinarily sets parameters for carrying out a suitable simulation. However, equipment trouble (an error state) can be simulated by the equipment simulator by receiving input of the PID parameters in which an error will intentionally occur. Therefore, equipment trouble can be ascertained without operating real equipment.

The invention according to a third aspect is an equipment design and manufacturing support system for supporting design and manufacture of processing equipment, the equipment design and manufacturing support system having an equipment simulator, an equipment controller, an EES, and a parameter setting system, wherein the equipment simulator receives input of equipment layout data of real equipment, and executes simulation processing using PID control as virtual processing equipment via a simulation program that corresponds to each level of the real equipment on the basis of the equipment layout data and a control command from the equipment controller; the equipment controller presents to the real equipment and the equipment simulator a control command for controlling the real equipment and virtual processing equipment in the equipment simulator; the EES acquires the execution results of simulation processing in the virtual processing equipment in the equipment simulator, and the execution results in the real equipment; the parameter setting system acquires the execution results in the real equipment at two points in time, calculates the PID parameters to be used in the equipment simulator at each of the time points on the basis of the acquired execution results, and calculates a variation value per unit interval of the PID parameters using the calculated PID parameter; and the equipment simulator updates the PID parameters on the basis of the variation value calculated in the parameter setting system.

With the configuration of the present invention, the variation value of the PID parameters used in the simulation processing in the equipment simulator can be calculated in the same manner as the first aspect described above. Specifically, variation in the equipment state and change over time that occurs in real equipment can also be reflected in the equipment simulator.

The invention according to a fourth aspect is an equipment design and manufacturing support system for supporting design and manufacture of processing equipment, the equipment design and manufacturing support system having an equipment simulator, an equipment controller, an EES, and a parameter setting system, wherein the equipment simulator receives input of equipment layout data of real equipment, and executes simulation processing using PID control as virtual processing equipment via a simulation program that corresponds to each hierarchy of the real equipment on the basis of the equipment layout data and a control command from the equipment controller; the equipment controller presents to the real equipment and the equipment simulator a control command for controlling the real equipment and virtual processing equipment in the equipment simulator; the EES acquires the execution results of simulation processing in the virtual processing equipment in the equipment simulator, and the execution results in the real equipment; the parameter setting system acquires the execution results in the real equipment at two points in time, calculates the PID parameters to be used in the equipment simulator at each of the time points on the basis of the acquired execution results, calculates a PID waveform at each of the two points in time using the calculated PID parameter, and calculates a variation value for each unit interval by comparing the calculated PID waveforms; and the equipment simulator updates the PID parameters on the basis of the variation value calculated in the parameter setting system.

With the configuration of the present invention, the variation value of the PID parameters used in the simulation processing in the equipment simulator can be calculated in the same manner as the second aspect described above. In other words, variation in the equipment state and change over time that occurs in real equipment can also be reflected in the equipment simulator.

In the aspect described above, the equipment design and manufacturing support system may be configured as a equipment design and manufacturing support system that furthermore has reproduction equipment, wherein the reproduction equipment executes simulation processing as virtual processing equipment via a simulation program that corresponds to each hierarchy of the real equipment on the basis of the control command in the real equipment and/or the execution results.

Simulation processing can be carried out based on the execution results and a control command in the equipment by providing reproduction equipment in the manner of the present invention. Therefore, the same environment as the equipment, e.g., in a remote location, can be reproduced as long as the control command and execution results can be acquired. For example, when the equipment malfunctions, the cause of the malfunction can be diagnosed away from the factory because the same event as the event that occurred in the equipment can be reproduced without traveling to the factory where the equipment is installed.

In the aspect described above, the equipment design and manufacturing support system may be configured so that position information of material to be processed according to a control command is included in the execution results; and the reproduction equipment displays simulation processing from the viewpoint of the material on the basis of the position information of the material in the execution results.

According to this aspect of the present invention, it is possible to display the simulation from the viewpoint of the material as well as to display the simulation in a conventional overview perspective. The viewpoint can thereby be automatically changed in accompaniment with the movement of the material, and the operating state of the equipment can be confirmed from the viewpoint of the material.

The invention according to a fifth aspect is a method for setting recipe data for an equipment parameter setting support system using an equipment design and manufacturing support system for supporting the design and manufacture of processing equipment, the method for setting recipe data using an equipment parameter setting support system characterized in that a recipe management system presents recipe data set in advance as initial values to an equipment controller of the equipment design and manufacturing support system; the equipment controller presents a recipe control command to an equipment simulator of the equipment design and manufacturing support system on the basis of the data of the recipe; the equipment simulator executes simulation processing on the basis of the data of the recipe and sends the execution result to the equipment controller or EES; and the recipe management system displays the execution results stored in the equipment controller or EES and receives a re-input of the recipe data, and the received recipe data is transferred from the recipe management system to the equipment controller of the equipment design and manufacturing support system, whereby a recipe control command based on new recipe data is transferred to the equipment simulator.

Conventionally, the actual processing equipment is used for carrying out verification in order to set the recipe. Accordingly, there is a drawback in that the manufacturing line must be temporarily stopped on such occasions. However, according to this aspect of the present invention, the recipe for operating the equipment can be set to a suitable recipe without operating the actual processing equipment to the extent possible.

### Effect of the Invention

Discrepancy in equipment performance between real equipment and the equipment simulator can be reduced to the extent possible by using the equipment parameter setting support system 1 of the present invention, even with changes over time in the equipment as such and changes in the state of the equipment. When the recipe is established, the recipe can be set with suitable settings without using real processing equipment to the extent possible.

### BRIEF DESCRIPTION OF THE DRAWINGS

FIG. 1 is a schematic view of equipment in an equipment design and manufacturing support system used by the equipment parameter setting support system of the present invention;

FIG. 2 is a schematic view showing a conceptual example of the equipment simulator;

FIG. 3 is a schematic view showing a conceptual example of the entire software configuration of an equipment design and manufacturing support system that operates in relation to the equipment parameter setting support system of the present invention;

FIG. 4 is a schematic view showing an example of the hardware configuration of a computer for implementing the equipment simulator, EES, equipment controller, recipe management system, parameter setting system, and the like;

FIG. 5 is a schematic view showing an example of processing for adjusting the parameters of real equipment based on simulation verification results;

FIG. 6 is a schematic view showing a hierarchical model of equipment;

FIG. 7 is a schematic view showing an example of recipe information;

FIG. 8 is an example showing the execution results based on a control command of the recipe information, and the execution results based on a control command of sequence control;

FIG. 9 is a diagram showing the PID waveform characteristics;

FIG. 10 is a block diagram showing PID control with two degrees of freedom;

FIG. 11 is a schematic view of the workflow of an equipment design and manufacturing support system;

FIG. 12 is an example of a flowchart that schematically shows the processing of the simulation processing unit;

FIG. 13 is an example of a wafer processing list used for processing in an equipment simulator;

FIG. 14 is another example of a wafer processing list used for processing in real equipment;

FIG. 15 is a schematic view of equipment in another example of an equipment design and manufacturing support system used by the equipment parameter setting support system of the present invention;

FIG. 16 is an example of a screen in the case that simulation processing is carried out;

FIG. 17 is an example of a screen in the case that simulation processing is carried out from the viewpoint of the material;

FIG. 18 is an example of a schematic diagram of a configuration of the parameter setting system;

FIG. 19 is an example of a flowchart showing the processing in the parameter setting system;

FIG. 20 is an example of a schematic diagram of another configuration of the parameter setting system;

FIG. 21 is an example of a flowchart showing the other processing in the parameter setting system;

FIG. 22 is an example of a screen in the case that the PID parameters are calculated at two points in time in the parameter setting system;

FIG. 23 is a diagram showing the mathematical formula that is used in the case of exhaust simulation in vacuum equipment; and

FIG. 24 is an example of a screen in the case that parameters are calculated at two points in time of a vacuum equipment in the parameter setting system.

### DESCRIPTION OF THE NUMERICAL SYMBOLS

1: Equipment parameter setting support system
2: Equipment simulator
3: Equipment controller
4: EES
5: CAD
6: Real equipment
7: Reproduction equipment
11: Recipe management system
12: Parameter setting system
20: Modeling layout unit
21: Data storage unit
22: Simulation processing unit
23: Display processing unit
30: Computation device
31: Storage device
32: Display device
33: Input device
34: Communication device
121: Execution results acquisition unit
122: Parameter calculation unit
123: Difference calculation unit
124: Variation value calculation unit
125: Data transmission unit
126: Waveform calculation unit
127: Waveform comparison unit

### BEST MODE FOR CARRYING OUT THE INVENTION

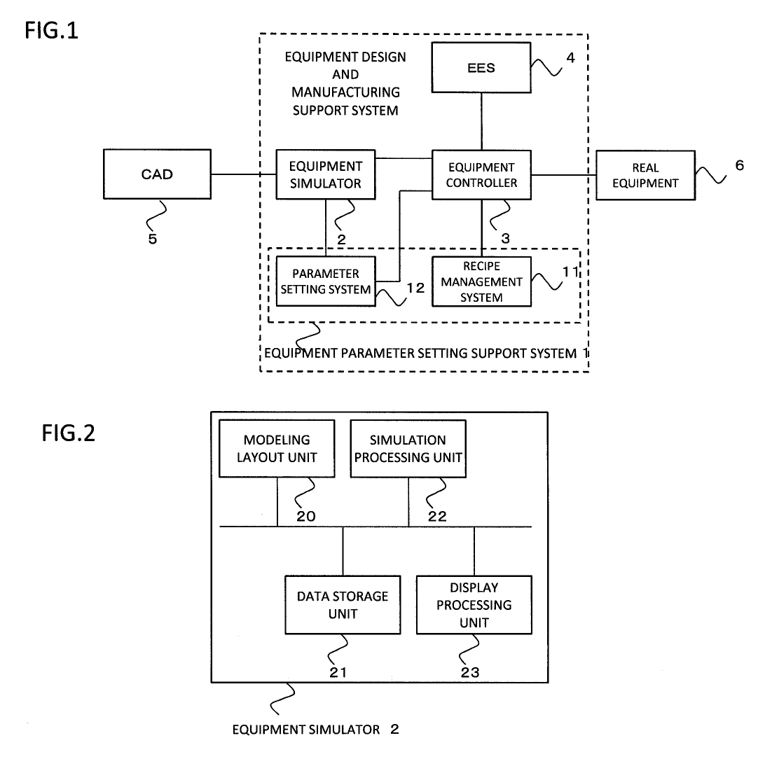

The equipment parameter setting support system 1 of the present invention is used in combination with the equipment design and manufacturing support system described below. Schematically shown in FIG. 1 is the equipment constituting an equipment parameter setting support system and an equipment design and manufacturing support system provided with the equipment parameter setting support system. The equipment design and manufacturing support system is preferably used in, but not limited to, semiconductor manufacturing equipment, flat panel manufacturing equipment, solar-cell manufacturing equipment, micro electromechanical systems (MEMS) manufacturing equipment, automated biological analysis equipment, pharmaceutical-products manufacturing equipment, foodstuffs manufacturing equipment, and various other equipment (processing equipment); and is more specifically used in the design and manufacture of processing equipment or the like that operate in accordance with a recipe (a collection of processing conditions (parameters or the like) for executing processes). In the description below, the case of semiconductor manufacturing equipment as the processing equipment will be described, but application can similarly be made to other processing equipment.

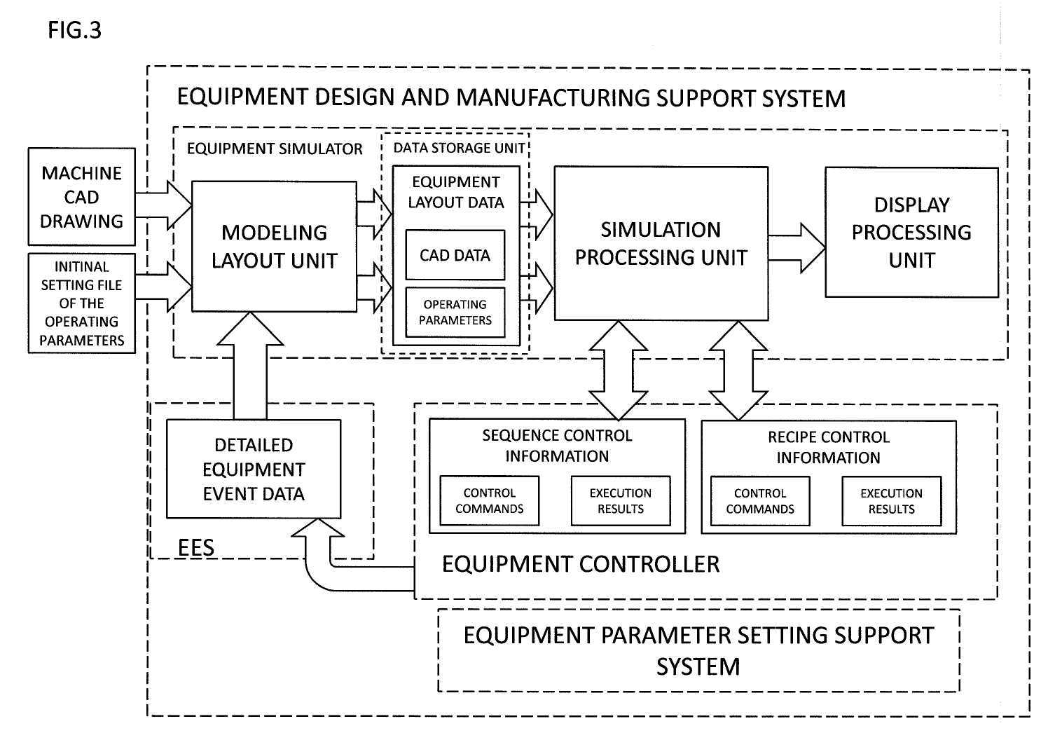

The equipment parameter setting support system 1 has a recipe management system 11 and a parameter setting system 12. The equipment design and manufacturing support system has an equipment simulator 2, an equipment controller 3, an EES 4, and the equipment parameter setting support system 1. FIG. 2 is a schematic view showing a conceptual example of the equipment simulator 2. FIG. 3 is a schematic view showing a conceptual example of the entire software configuration of an equipment design and manufacturing support system that operates in relation to the equipment parameter setting support system.

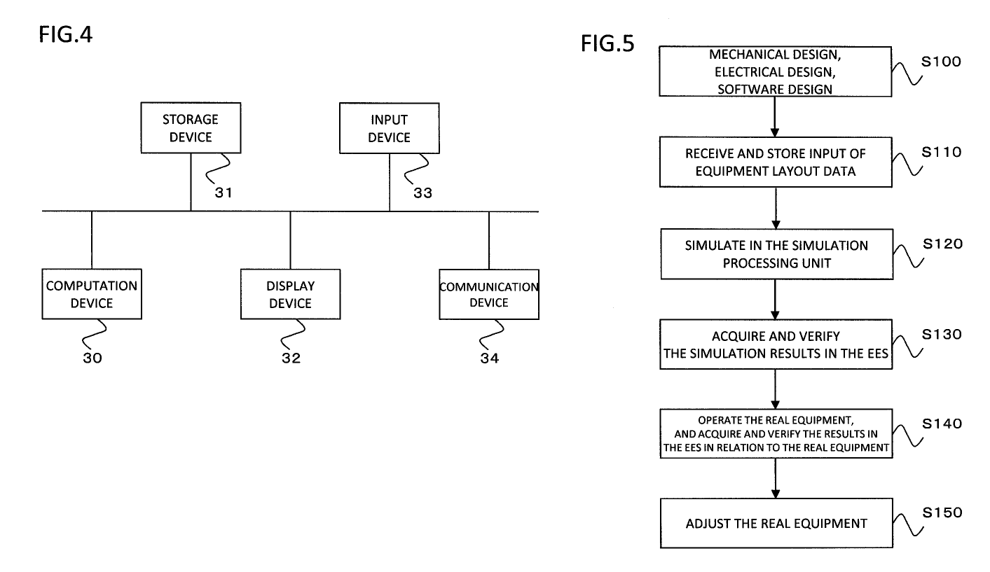

A computer, predetermined computation circuits, and the like are used for the equipment simulator 2, EES 4, equipment controller 3, recipe management system 11, and parameter setting system 12. FIG. 4 is a schematic view showing an example of the hardware configuration of a computer for implementing the equipment simulator 2, EES 4, equipment controller 3, recipe management system 11, parameter setting system 12, and the like.

The computer has at least a CPU or other computation device for executing computation processes of a program; a RAM, hard disk, or other storage device 31 for storing information; and communication device 34 for sending and receiving processing results of computation device 30 and information stored in the storage device 31 via the Internet, LAN, or another network. The processing of functions (means) implemented on the computer is carried out by reading means (programs, modules, or the like) for executing the processing into the computation device 30. The functions are used for reading relevant information from the storage device 31 and processing the information thus read as needed in the computation device 30 in the case that information stored in the storage device 31 is to be used in the processing. The computer may have a keyboard, mouse, ten-key, or other input device 33, and a monitor or other display apparatus 32.

The functions of means in the present invention are only logically differentiated and may physically or practically constitute the same area. The functions, computer, and the like may be integrated or may be distributed in any desired manner.

The equipment parameter setting support system 1 of the present invention is used by being combined with an equipment design and manufacturing support system. Accordingly, the configuration apart from the equipment parameter setting support system 1 of the equipment design and manufacturing support system will be described first.

The equipment simulator 2 receives input of mechanical drawings and other CAD data generated in CAD 5, receives operating parameters (described below) that correspond to the CAD data, and stores the information and parameters as equipment layout data. The equipment simulator is a computer that displays the simulation status of the processing equipment on the basis of the equipment layout data.

The equipment simulator 2 has a modeling layout unit 20, a data storage unit 21, a simulation processing unit 22, and a display processing unit 23.

The modeling layout unit 20 receives input of CAD data of real equipment 6 (described below) generated in the CAD 5 and stores the data in a later-described data storage unit 21. For example, information indicating the size, and position information of components of the processing equipment generated in a 2D CAD and a 3D CAD are stored as CAD data. Also, the modeling layout unit 20 receives input of initial settings of operating parameters indicating the timing and manner in which the above-noted components will be operated. This may be achieved by reading the file in which the operating parameters of the components are set, or by receiving input of operating parameters of the components from the input device 33.

Operating parameters inputted in this manner are associated with CAD data stored in the data storage unit 21, and the CAD data and operating parameters are stored in the data storage unit 21 as equipment layout data. This association may be handled as a single (or related) equipment layout data by including identical identification information in each file, or may be combined together in a single file as single equipment layout data.

The CAD data read by the modeling layout unit 20 may be information (position information, size information, and the like) generated by the CAD 5 in relation to all the components constituting the processing equipment, or may be information not required for simulation processing in the later-described simulation processing unit 22 among the components constituting the processing equipment, i.e., information that does not include information related to components that are not displayed when the processing equipment is observed from the exterior (or information related to components displayed when the processing equipment is observed from the exterior). In the case of the latter, the information related to components that cannot be observed from the exterior is subtracted from the CAD data and stored in the data storage unit 21. In this case, the amount of CAD data is reduced and does not lead to a reduction in the speed at which simulation processing takes places.

The equipment layout data in the modeling layout unit 20 will now be described. In relation to the CAD data generated in the CAD 5, the components (objects) in each hierarchy constituting the real equipment 6 are first registered and set in the modeling layout unit 20. In other words, the drawings of the components for 3D display are read and the layout settings are carried out. Next, the object attributes are set. The object attributes set in this case include position information of the object, operation time (initially, design value data) and other operation parameters, and I/O map information (e.g., number of actuators, number of sensors, I/O map, and the like) of device operation specifications. When the object attributes are set in this manner, the objects are arranged in 3D. Operating parameters are set by similarly carrying out this work for equipment, modules, subsystems, and the like. It is therefore possible to generate equipment layout data that includes operating parameters and CAD data for the entire processing equipment. In the case of 2D CAD 5, the above-described processing can be carried out without change in 2D.

The data storage unit 21 stores equipment layout data and various other data and required data is read as needed and used for processing when processing takes place in the later-described simulation processing unit 22.

The simulation processing unit 22 executes simulation processing in accordance with a simulation program stored in advance in order to simulate real equipment 6 using the equipment layout data stored in the data storage unit 21. The simulation program used in this case is a simulation program of the real equipment 6 being designed and manufactured using the equipment design and manufacturing support system, and simulation processing is carried out in accordance with a control command (described below) from the equipment controller 3 when simulation processing is to be carried out.

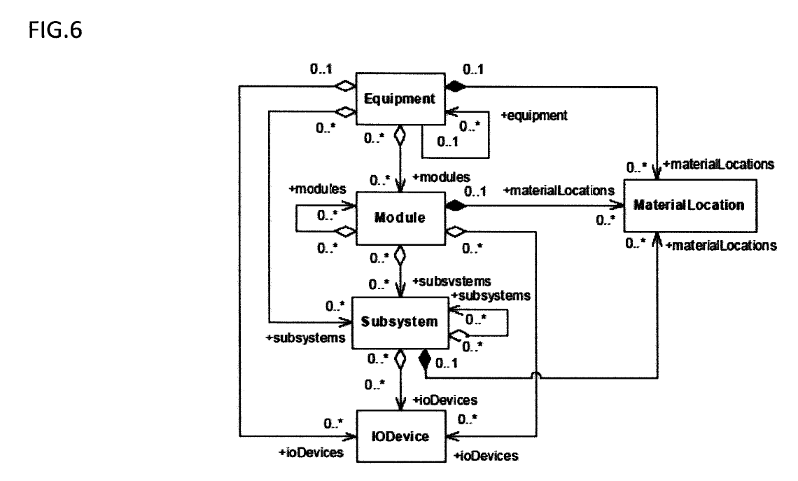

The object to be controlled is hierarchized in similar fashion to the real equipment 6 and processing is carried out in order to virtually simulate the real equipment 6 using the simulation processing unit 22. FIG. 6 is a schematic view showing the hierarchical model of equipment.

First, the real equipment 6 is divided into a four-level hierarchy. In other words, an equipment level, a module level, a subsystem level, and an I/O device level. The real equipment 6 provides levels of the material which serves as the object of manufacture. Therefore, the simulation program that functions in the simulation processing unit 22 is divided into a total of five levels to carry out control processing. Each level is composed of a program for controlling the level, and the programs are controlled on the basis of control commands of the equipment controller 3, whereby simulation processing is executed.

The equipment level is a level for defining the space in which the equipment is arranged, or objects (components) at the module level and there below can be arranged, and is composed of modules, subsystems, and I/O devices.

The module level is composed of modules, subsystems, and I/O devices and is a level for executing processes or transfer materials in the equipment and defining constituent elements that can be replaced

The subsystem level is composed of subsystems and I/O devices and is a level for defining constituent elements that can be replaced and that have specific functions within a module.

The I/O device level has the smallest control function for operating the equipment, and is a level composed of sensors, actuators, and various other I/O devices, examples of which include pumps, valves, robots, shutters, lifters, and power sources.

The material level is a level showing material fed into the equipment and transported within the equipment. Examples include a front opening unified pod (FOUP), a wafer, and a substrate. The material level has position information referred to as material location inside the equipment and information indicating whether material is actually present in a material location.

The real equipment 6 is actually composed of equipment, modules, subsystems, and I/O devices, and these carry out manufacturing processes related to the material. When processing is to be carried out in the simulation processing unit 22, the equipment controller 3 can be reliably synchronized in similar fashion to the case in which the real equipment 6 is actually operated by dividing the levels of the material (material levels) as the object of manufacturing into the four levels (equipment level, module level, subsystem level, I/O level) constituting the real equipment 6, so as to correspond to the configuration of the real equipment 6. Operation can be verified for each level.

The levels can be divided in any manner in accordance with the characteristics of the processing equipment to be designed and manufactured.

Since PID control is used in the real equipment 6, it is also used in the simulation processing unit 22. In other words, simulation processing is carried out using PID parameters used PID control.

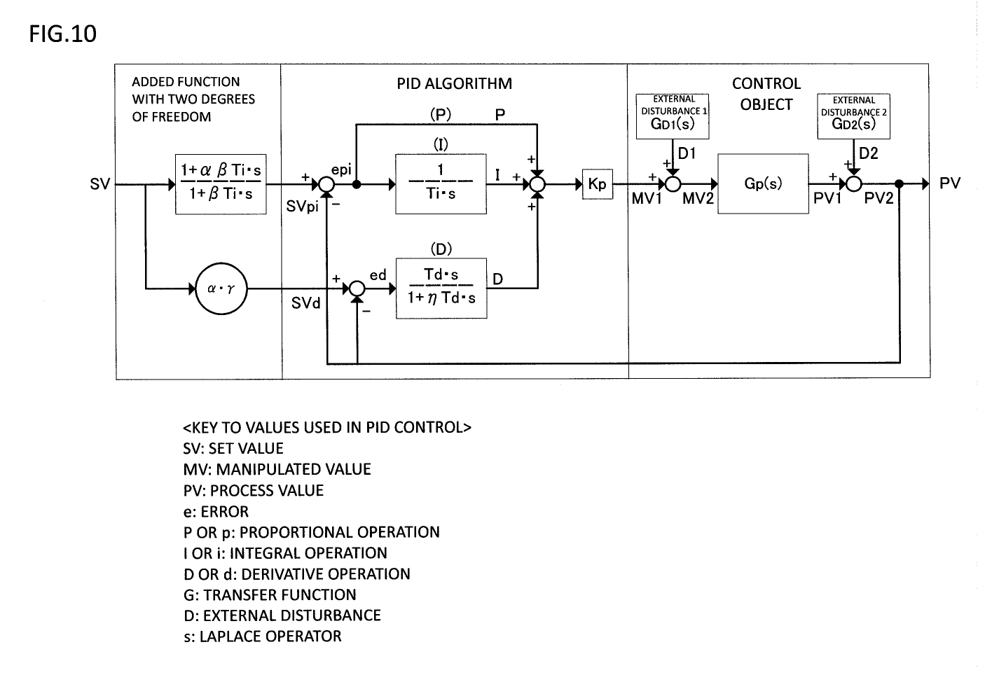

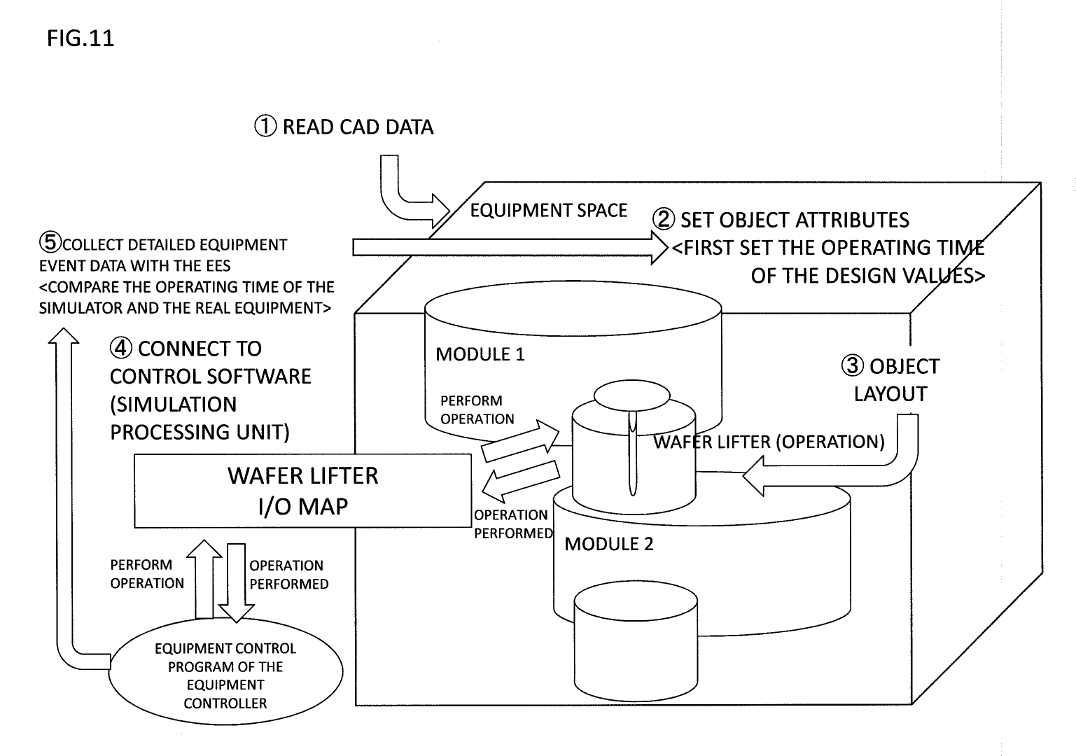

FIG. 10 is a block diagram schematically showing the PID control mechanism in the real equipment 6 and the simulation processing unit 22. The PID control mechanism of FIG. 10 is a PID control mechanism having optional functions providing two degrees of freedom. In the block diagram of FIG. 10, “SV” is the set value as the control command based on the recipe information, “MV” is a manipulated value, “PV” is a process value, “e” is a error, “P” or “p” is proportional operation, “I” or “i” is integral operation, “D” or “d” is derivative operation, “G” is a transfer function, “D” is external disturbance, and “S” is a Laplace operator.

The PID control is control for obtaining a control command and execution results (observed values) related to the control command in a single recipe step. The PID parameters (Kp: proportional gain, Ti: integral time (s), Td: derivative time (s), η: differential coefficient, α: coefficient for obtaining two degrees of freedom in proportional gain, ρ: coefficient for obtaining two degrees of freedom in integral time, γ: coefficient for obtaining two degrees of freedom in derivative time) are set in accordance with the characteristics of each single instruction carried out by PID control.

The display processing unit 23 displays the processing results in the simulation processing unit 22 on the display apparatus 32 of the equipment simulator 2 or a predetermined computer terminal.

The equipment controller 3 is a computer for carrying out control commands of virtual processing equipment (processing equipment in which the operation of the real equipment 6 has been implemented in a computer) in the real equipment 6 or the simulation processing unit 22, and can switch between at least two control modes, i.e., real control mode and equipment simulation mode.

Examples of the control commands that the equipment controller 3 sends to the real equipment 6 or the virtual processing equipment include control commands (sequence control commands) that direct the operation of components constituting the equipment, the transport route, and the like; and recipe control commands that indicate the processing methods (processing conditions) and the like in the equipment, modules, and components constituting the equipment and modules. An example of a sequence control command is elevating and lowering a lifter. Examples of the recipe control command include conditions related to time, gas flow rate, power, temperature, and the like.

The equipment controller 3 sends sequence control commands and recipe control commands to the real equipment 6 or virtual processing equipment, and acquires the execution results of the commands from the real equipment 6 or the virtual processing equipment. The acquired data is stored in the later-described EES 4.

The real control mode is a mode for causing the real equipment 6 to operate by making connections with sensors, actuators, or the like in real processing equipment (real equipment 6), and by sending sequence control commands and recipe control commands to the real equipment 6. The execution results are received from the real equipment 6 in the case that the execution has been carried out in the real equipment 6.

The equipment simulation mode is a mode for causing equipment to operate in a virtual manner by sending sequence control commands and recipe control commands to the simulation processing unit 22 of the equipment simulator 2. In the case that execution has been carried out in the simulation processing unit 22 of the equipment simulator 2, the execution results are received from the simulation processing unit 22. In the equipment simulation mode, the execution speed of the simulation processing can be carried out at the same speed (identical) as during control of the real equipment 6, or at double speed, triple speed, or any other execution speed. The time required for confirmation can thereby be shortened.

There are two cases in the equipment controller 3, i.e., a case for controlling the entire real equipment 6 or virtual processing equipment using a computer, and a case for controlling the real equipment 6 or the virtual processing equipment using PLC. Either of these cases may be used, but control commands (sequence control commands and recipe control commands) of the case that is used are sent to the real equipment 6 or the equipment simulator 2.

These control commands (sequence control commands and recipe control commands) are information for controlling processing in each level of the real equipment 6 or the simulation processing unit 22 of the equipment simulator 2, and is the same or essentially the same information (information in which the semantic implication for control is the same) whether the object to be controlled is the real equipment 6 or the virtual processing equipment. Control commands include instruction information for starting control in the real equipment 6 or the simulation processing unit 22 of the equipment simulator 2, and additional information that indicates the conditions in which control is carried out.

The equipment controller 3 receives the processing results in each level of the real equipment 6 or the simulation processing unit 22 of the equipment simulator 2 as the execution results from the real equipment 6 or the simulation processing unit 22 in response to the above-described control commands (sequence control commands and recipe control commands). Whether the real equipment 6 or the virtual processing equipment has carried out the processing, the execution results are the same or essentially the same information (information in which the semantic implication for execution results is the same). The execution results include information from the real equipment 6 and the simulation processing unit 22 of the equipment simulator 2 that the processing related to the control commands has ended (or information that the processing related to the control commands resulted in an error), as well as additional information that indicates the state resulting from the execution.

The control commands and execution results are generically referred to as control information. The control information (control commands and execution results) when the equipment controller 3 is a computer is device sequence step control information, and the control information (control commands and execution results) when the equipment controller 3 is PLC is referred to as a device sequence step I/O map (PLC control information). Also, recipe information (control commands and execution results) is provided even when the equipment controller is a computer or a PLC.

The EES 4 (equipment engineering system) acquires detailed control information (control commands and execution results) of the real equipment 6 or the virtual processing equipment for carrying out simulation in the simulation processing unit 22 of the equipment simulator 2, and is a computer for analyzing the operation (information may be directly acquired from the real equipment 6 or the equipment simulator 2 without going through the equipment controller 3). Data that may be acquired in this case includes detailed equipment event data (operation logs of various equipment (including components) constituting the processing equipment), trace data (temperature, pressure, and other information of the processing equipment that changes over time, components thereof, material, or the like), and context data (information indicating material units as the object of processing, i.e., batch ID, lot ID, substrate ID, wafer ID, recipe ID, recipe information, and the like). Context data may be included in the details equipment event data. In other words, the detailed equipment event data, trace data, context data are the control commands and the execution results. Therefore, the EES 4 has a function for collecting the control commands and execution results of the real equipment 6 or the virtual processing equipment, a function for confirming the operation times thereof, and other functions. These functions are carried out by acquiring data (detailed equipment event data, trace data, and context data) indicating the control commands, the execution results, and other control information from the real equipment 6 controlled by the equipment controller 3 or from the virtual processing equipment.

The device operation, and start and end times are included in the detailed equipment event data as the additional information in the control commands and execution results. Therefore, the operation time can be calculated from the difference between the start and end times.

The CAD 5 is equipment for generating CAD data of the drawings of the real equipment 6 and may be a 2D CAD 5 for generating 2D drawings or a 3D CAD 5 for generating 3D drawings. The case of a 3D CAD 5 is described below, but a 2D CAD 5 or a 3D CAD 5 may be used, and the same technical effects can be obtained with the same processing.

The design of the real equipment 6 in the CAD 5 is carried out in a conventional manner.

The real equipment 6 is an actual processing equipment, examples of which include semiconductor manufacturing equipment, flat panel manufacturing equipment, solar-cell manufacturing equipment, MEMS manufacturing equipment, automated biological analysis equipment, pharmaceutical-products manufacturing equipment, foodstuffs manufacturing equipment, and various other processing equipment. Equipment in the real equipment 6 is simulated using the equipment simulator 2 in the equipment design and manufacturing support system described above.

Described next is the equipment parameter setting support system 1 used in the equipment design and manufacturing support system.

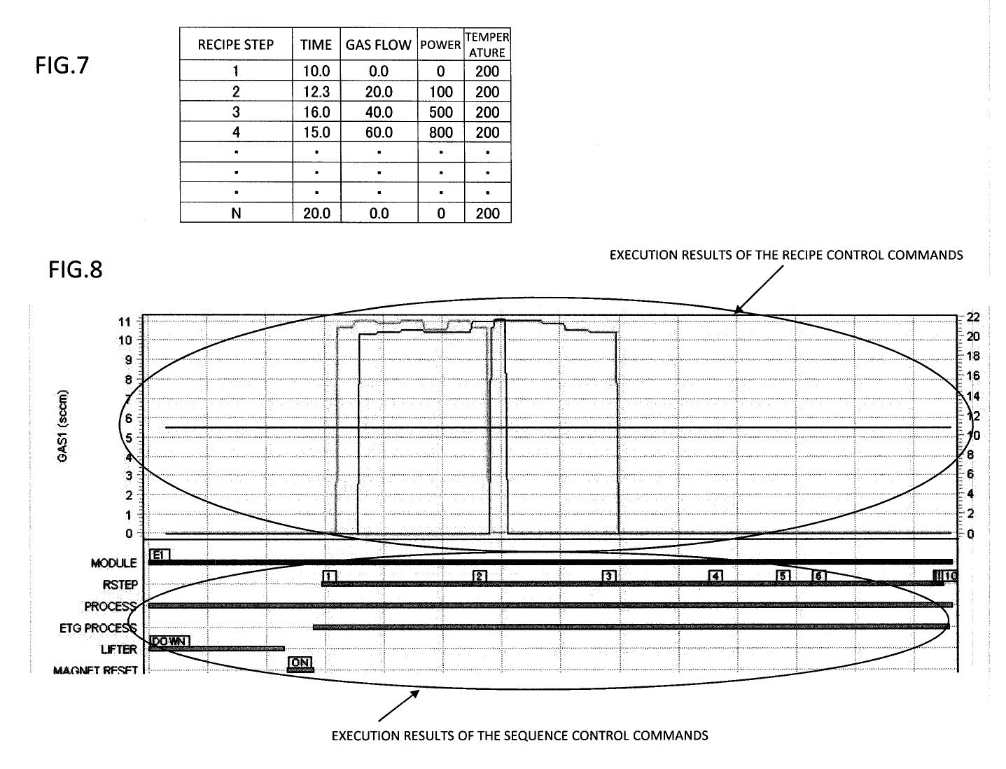

The recipe management system 11 is a computer system for editing and managing recipes (recipe data) that constitute recipe control commands in the equipment controller 3 for sending control commands (sequence control commands and recipe control commands) to the real equipment 6 or the equipment simulator 2. FIG. 7 shows an example of recipe data.

The recipe data of FIG. 7 indicates that the processing in each level constituting the real equipment 6 and the equipment simulator 2 is carried out by the equipment, modules, components in accordance with a sequence (recipe step) established for each. For example, in recipe step 1, the processing conditions are a gas flow set to 0.0 sccm, power set to 0 KW, and the temperature set to 200° C. for 10 seconds. Accordingly, the data are sent to the real equipment 6 or the equipment simulator 2 from the equipment controller 3 as recipe control commands, which are target values. Similarly, after recipe step 1 has been completed, in recipe step 2, the gas flow is set to 20.0 sccm, the power set to 100 KW, and the temperature set to 200° C. for 12.3 seconds. Therefore, the data are sent from the equipment controller 3 to the real equipment 6 or the equipment simulator 2 as recipe control commands.

Such recipe data is initially set based by the engineer based on personal experience or another source. The recipe data thus set is then sent from the recipe management system 11 to the equipment controller 3. With the attribute thus received, the equipment controller 3 sends recipe control commands to the virtual processing equipment on the basis of the recipe data (sequence control commands may also be sent in addition to recipe control commands). Processing is carried out by the virtual processing equipment on the basis of the recipe control commands and the sequence control commands, and the execution results (controlled values (observed values)) in relation to the control are received in the equipment controller 3 (or EES 4). Therefore, the recipe management system 11 receives the results from the equipment controller 3 (or EES 4). The execution results are then displayed as a graph by the recipe management system 11. When the graph is created, the control commands (target values) may also be displayed in conjunction for comparison. FIG. 8 shows a schematic view of such an example.

The engineer visually confirms the graph displayed in the recipe management system 11 and corrects the recipe data, and the recipe data is sent again to the equipment controller 3. The recipe control commands from the equipment controller 3 are sent to the virtual processing equipment, whereby the execution results are again acquired via the equipment controller 3 (or EES 4) and displayed in the form of a graph in the recipe management system 11. Such work is carried out a plurality of times until the recipe data is accepted by the engineer.

Thus, in the recipe management system 11, processing is not directly carried out in the real equipment 6 on the basis of the recipe data set by the engineer, and a simulation is carried out in the equipment simulator 2 of the equipment design and manufacturing support system, whereby the recipe data can be set. When the execution results are acceptable, the equipment controller 3 is switched to the real control mode for the first time in order to make a final confirmation, and control based on the recipe data is carried out in the real equipment 6. Therefore, the number of times that the real equipment 6 is operated can be reduced.

The parameter setting system 12 is a system for setting PID parameters used when simulation processing carried out in the simulation processing unit 22 and when the PID control is carried out in the real equipment 6; and is a system in which parameters are set using automated control in the case of automated control in which PID control is not carried out.

In the PID control scheme that is used in the real equipment 6 and when simulation processing is carried out in the simulation processing unit 22, the parameters must be adapted to the environment of the real equipment 6. Therefore, optimal parameters that use PID control must first be set using known techniques described in Patent Documents 1 and 2. There are many known techniques other than the methods described in Patent Documents 1 and 2, and such methods may be used as needed and the parameters may be set in suitable fashion. The PID parameters set in this state are PID parameters in an ideal state.

The real equipment 6 operates in a near ideal state in an initial state and immediately after maintenance, but components degrade over time, and the environment changes due to the accumulation of unwanted matter and other causes. As an example of the above, a gas pipe may become plugged during gas flow rate control and exhaust velocity may be changed in a vacuum pump.

Thus, in the case there are changes in the environment of the real equipment 6, it is not possible to respond to changes in the environment with the PID parameters set in a near ideal state. In view of the above, the PID parameters are adjusted in accordance with the real environment of the real equipment 6 using the parameter setting system 12.

Specifically, the execution results (detailed equipment event data, trace data that corresponds thereto, and context data) are first acquired from the equipment controller 3 or the EES 4 at a certain point and the execution results are acquired at another time point after a fixed time interval has elapsed thereafter, and the PID parameters that correspond to each of the time points are calculated.

The difference between the PID parameters at the two points in time is thought to be the change during the fixed time interval described above. Therefore, the difference in the PID parameters are divided by the elapsed time from a reference time, whereby the variation value (differential) of the difference in the PID parameters of each unit interval can be calculated.

For example, the difference between the PID parameters in the initial state and the PID parameters after 90 days had elapsed is calculated, the difference is divided by 90, and the variation value of the PID parameters per day can be calculated. Accordingly, the parameter setting system 12 carries out processing to reflect the changes in the equipment state and the change over time in the real equipment 6 by taking the variation values into consideration (e.g., adding, subtracting, or carrying out other computations) on a daily basis and storing the results in the PID parameters set in the equipment simulator 2.

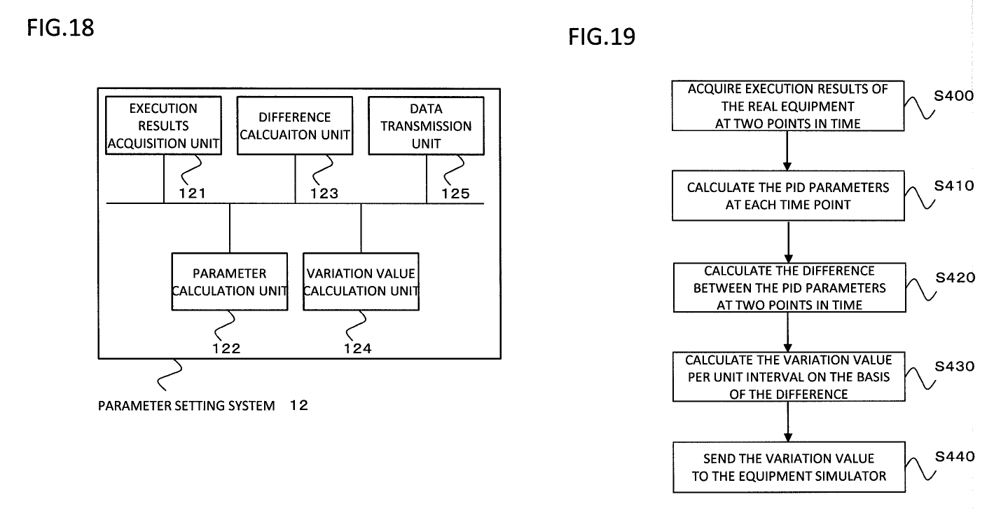

In order to carry out this computation, the parameter setting system 12 has an execution results acquisition unit 121, a parameter calculation unit 122, a difference calculation unit 123, a variation value calculation unit 124, and a data transmission unit 125. FIG. 18 is an example of a conceptual view schematically describing the concept of the parameter setting system 12.

The execution results acquisition unit 121 acquire the execution results, which are the results of the operation and processing of the real equipment 6, from the equipment controller 3 or the EES 4 on the basis of the sequence control commands and/or the recipe control commands from the equipment controller 3. The execution results acquired in this case are the execution results at two points in time. The precision of the variation value described below can be improved by acquiring the execution results at two or more time points.

The parameter calculation unit 122 calculates optimal PID parameters at each of the time points on the basis of the execution results acquired by the execution results acquisition unit 121. These PID parameters can be calculated using the methods described in the patent documents above, using methods based on the block diagram shown in FIG. 10, or various other known methods.

The difference calculation unit 123 calculates the difference between the PID parameters calculated in the parameter calculation unit 122 at two points in time.

The variation value calculation unit 124 calculates the variation value (differential value) by dividing the difference between the PID parameters calculated in the difference calculation unit 123 by the unit interval at the two points in time. For example, in the case that the two points in time is 90 days and that the unit interval is one day, the variation value per day is calculated by dividing the difference in the calculated PID parameters by 90. In the case that the unit interval is three days, the variation value per three days is calculated by dividing the difference in the calculated PID parameters by 30.

The data transmission unit 125 updates the PID parameters stored in the equipment simulator 2 at each unit interval by sending the variation value per unit interval calculated in the variation value calculation unit 124 to the equipment simulator 2. For example, the PID parameters are updated daily in the case that the initial value of a single element of the PID parameters is 0.5 and the variation value per unit interval (e.g., one day) is 0.01. In other words, the update is 0.51, 0.52, and so forth. The update is preferably carried out at each unit interval, but no limitation is imposed thereby. The data transmission unit 125 is not required to send the variation value to the equipment simulator 2, and may send the variation value to the equipment constituting the equipment design and manufacturing support system, and via the equipment, the variation value may then be sent to the equipment simulator 2.

When the execution results are to be acquired at three or more time points by the execution results acquisition unit 121, it is also possible to calculated the variation value every two points in time.

As described above, the difference between the parameters at two points in time may be used, but it is also possible to set the parameters on the basis of the waveform of the PID parameters of two points in time.

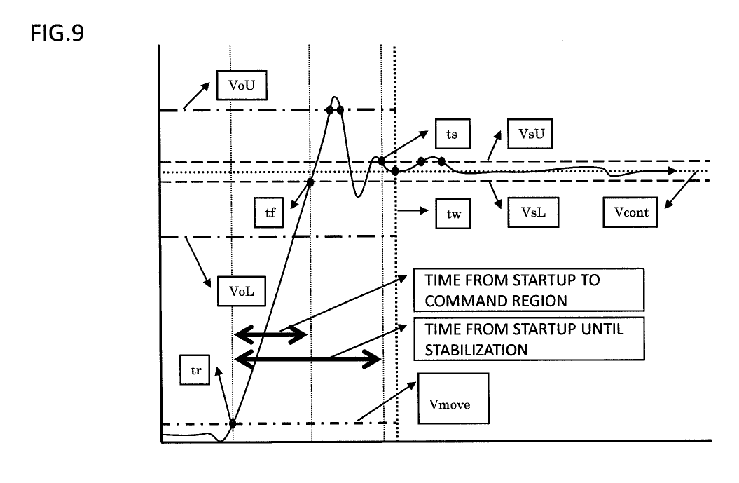

The equipment controller 3 sends the recipe control commands (and sequence control commands) in each recipe step to the equipment simulator 2. Specifically, control commands in which the values have been varied are send in each recipe step. The recipe steps are thereby accompanied by a transition phenomenon, as shown in FIG. 9.

In FIG. 9, “Vcont” is the target value (control command) in the cut-away waveform portion, “tw” is the time (stability wait time) from the first data of the trace until stability has been achieved, “VoU” is the upper limit value (overshoot upper limit value) of the transition period tf-tw, “VoL” is the lower limit value (overshoot lower limit value) of the transition period tf-tw, “VsU” is the upper limit value (stable period upper limit value) in the stable period (tw-trigger end period), “VsL” is the lower limit value (stable period lower limit value) in the stable period (tw-trigger end period), “Vmove” is the value (fluctuation-conclusion value) used for concluding that a value has fluctuated, “tr” is the point (response time) at which the fluctuation-conclusion value has been exceeded from the waveform start, “tf” is the setting upper/lower limit value of the stable period and the point (arrival time) at which the threshold values of Vs (VsU and VsL) have been exceeded from the waveform start, “ts” is the setting stability upper/lower limit value within the setting Tw time from the waveform start and is the point (stability time) at which the value has entered into the range of the threshold values of Vs (VsU and VsL) and stabilized.

A transition period and a stable period can therefore be concluded in relation to a single recipe control command. The startup time is preferably reduced and the stable time is extended to the extent possible in PID control, but this therefore leads to an increase in the overshoot width of the waveform of the transition period. In view of this situation, the PID parameters are set in accordance with the characteristics of the recipe control commands with consideration given to the above facts. In other words, when the recipe control commands have been set, optimal PID parameters can be set as long as the PID waveform can be calculated in the recipe step.

In view of the above, with the parameter setting system 12, a plurality of recipe control commands specified by the recipe data is calculated for each recipe step, and the PID waveform while the steps are executed is formed into a graph, whereby the PID parameters are set in a suitable manner with change over time and change in the equipment state taken into consideration.

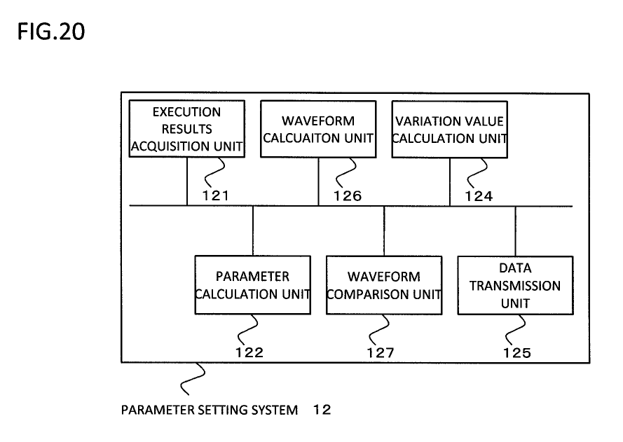

The parameter setting system 12 in this case has a waveform calculation unit 126 and a waveform comparison unit 127 in place of the difference calculation unit 123 described above. FIG. 20 shows an example of a schematic diagram of the concept of the parameter setting system 12 in this case.

The waveform calculation unit 126 calculates the PID waveform at each time point on the basis of the PID parameters calculated in the parameter calculation unit 122.

The waveform comparison unit 127 compares the PID waveforms at each time point calculated in the waveform calculation unit 126 and determines by comparison whether the forms are similar and whether there is a change in response.

The variation value calculation unit 124 in this case calculates the variation value of the PID parameters on the basis of the determination result of the waveform comparison unit 127 by comparison of the PID waveforms at each time point.

In the specific case that the waveform varies in an similar wave, among the PID parameters, the parameter setting system 12 reduces the proportional gain Kp when the variation is considerable, and increases the proportional gain Kp when the variation is low. The variation value calculation unit 124 calculates the variation value per unit interval at the two points in time described above in accordance with the similar wave ratio (the ratio by which the entire form has changed).

In the case that the responsiveness of the waveform increases (in the case that tf-tr or ts-tr is reduced), the parameter setting system 12 increases Ti as integral time in the PID parameters and reduces Td as the differential time.

In the case that the responsiveness of the waveform is reduced (in the case that tf-tr or ts-tr is reduced), the parameter setting system 12 reduces Ti as integral time in the PID parameters and increases Td as the derivative time.

The variation value calculation unit 124 calculates the variation value per unit interval at the two points in time described above in accordance with the improving or worsening ratio of waveform responsiveness (the ratio by which the entire form has changed).

When the variation value of the PID parameters is to be calculated on the basis of the PID waveform, a predetermined coefficient is used for carrying out computation (e.g., multiplication) with the varied ratio, but no limitation is imposed thereby, and the overall variation ratio of the PID parameters can be derived from the variation ratio of the waveform on the basis of a reference of the each of the PID parameters.

The parameter setting system 12 may carry out such modification processing when observed values (execution results in relation to control) have exceeded the threshold value of the stable interval, or when the allowable value of tf-tr or ts-tr has exceeded a threshold value.

### Example 1

An example of the processing of the equipment design and manufacturing support system combined with the equipment parameter setting support system 1 of the present invention will be described using a flowchart of FIG. 5. FIG. 11 schematically shows the workflow of the equipment design and manufacturing support system.

In similar fashion to convention methods, the machine design of the equipment is carried out in the machine design phase, wiring and other electrical design is carried out in the electrical design phase, and software is designed in the software design phase (S100). In machine and electrical design, components are ordered after design has been completed. In the machine and electrical design phases, design is carried out using a CAD 5, and the modeling layout unit 20 of the equipment simulator 2 reads the resulting CAD data. The CAD data thus read is stored in the data storage unit 21. Among the CAD data, nonessential information, e.g., component information inside the real equipment 6, or other information can be selectively deleted from the CAD data stored in the data storage unit 21 as required.

The modeling layout unit 20 reads (or receives input of) the initial setting file of the operating parameters indicating timing at which the objects constituting the levels of the real equipment 6 will operate, correlates the parameters with the CAD data, and then stores the information in the data storage unit 21. The CAD data and the operating parameters are correlated and stored as equipment layout data in the data storage unit 21 (S110).

The software at each level corresponding to the real equipment 6 and used for causing the processing equipment designed in the software designed phase to operate is read into the simulation processing unit 22 of the equipment simulator 2.

In this manner, when the equipment layout data containing the operating parameters is stored in the data storage unit 21, the equipment controller 3 is switched to the simulation mode (the mode may be switched manually or automatically; alternatively, a confirmation message about switching the mode may be displayed and the switch made when the user provides permission by input), and then presents sequence control commands and recipe control commands to the simulation processing unit 22 of the equipment simulator 2. Software read into the simulation processing unit 22 causes the processing equipment to function in a virtual manner and a simulation is carried out (S120) in accordance with the control commands, as well as the equipment layout data containing the operating parameters and stored in the data storage unit 21. The display processing unit 23 may be configured to display the state of an ongoing simulation on the display equipment 32. Since the sequence control commands and the recipe control commands have been transferred to the simulation processing unit 22, it is also possible for the EES 4 to acquire the commands as detailed equipment event data.

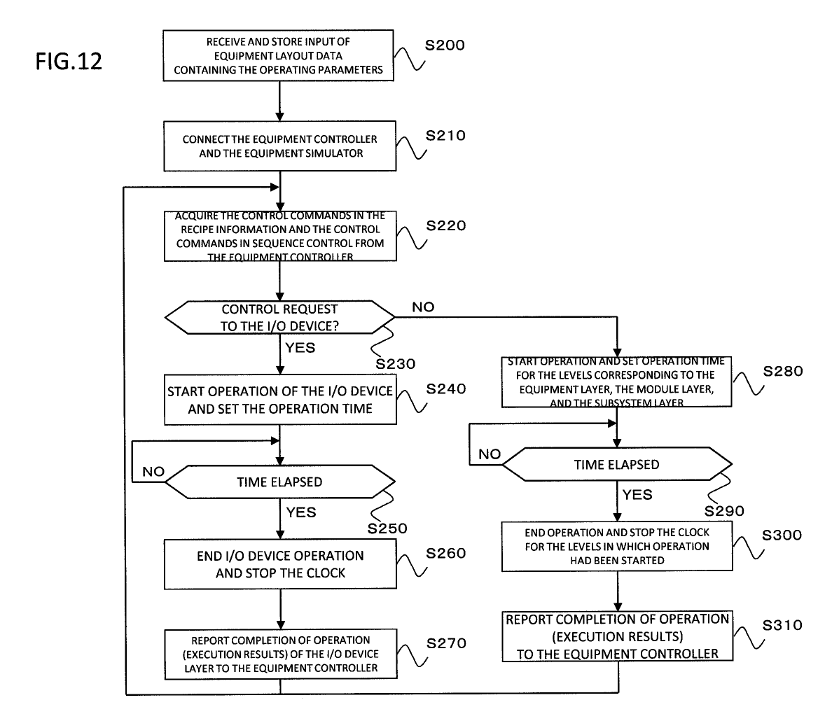

The simulation processing in the simulation processing unit 22 in S120 will be described using the flowchart of FIG. 12.

The input of the equipment layout data containing the operating parameters is received in the modeling layout unit 20 of the equipment simulator 2 (S200). This may be achieved by having the equipment simulator 2 receive input of CAD data from the CAD 5 via a network or the like, or receive input of CAD data via an magnetic disk, an optical disk, a magneto-optical disk, semiconductor memory, or the like. The input of the initial setting file of the equipment layout data that corresponds to the CAD data is received in the modeling layout unit 20 and stored in the data storage unit 21 as equipment layout data.

In the case that simulation processing is carried out in the equipment simulator 2, the equipment controller 3 and the equipment simulator 2 are connected in order to receive the sequence control commands and the recipe control commands from the equipment controller 3 (S210). This connection may be achieved by physical connect by a network cable to enable data transceiving, or by mutual connection to the Internet, LAN, or another network to enable logical data transceiving. The equipment controller 3 may automatically switch from real control mode to simulation mode by connecting to the equipment simulator 2. The equipment controller 3 and the equipment simulator 2 may also be connected by switching to simulation mode.

When the equipment controller 3 and the equipment simulator 2 are connected in such a manner, the sequence control commands and recipe control commands are transferred from the equipment controller 3 to the equipment simulator 2 and are acquired in the simulation processing unit 22 (S220). At this point, the EES 4 acquires the control commands as detailed equipment event data. Since the sequence control commands and the recipe control commands are independent of each other, these commands may be transferred with the same or different timing.

In the case that the sequence control commands and recipe control commands acquired in the simulation processing unit 22 are control commands to the program on the I/O device level in the simulation processing unit 22 (S230), the program of the I/O device level of the simulation processing unit 22 is started and processing in accordance with the control commands is carried out on the basis of the program. In other words, the operation of the I/O device of the virtual processing equipment is started (S240).

Since the operation of the I/O device layer is virtually started when the processing of the program of the I/O device layer is started, the timer (not shown) stored in the simulation processing unit 22 begins timer operation.

When the processing of the control commands has ended or when a predetermined processing time has elapsed (S250), the processing of the program on the I/O device level is ended. In other words, operation on the I/O device level is virtually ended, and the timer operation of the timer is ended (S260).

When the virtual operation on the I/O device level has ended, the simulation processing unit 22 presents the execution results to the equipment controller 3 in the form of an operation completion report (S270). The operation completion report containing the received execution results includes information (accessory information) indicating that processing of the sequence control commands has ended normally; the manner in which the operation and processing were (virtually) carried out in terms of processing start time, end time, and processing time; the state of the material as a result of the processing; position information (location information) indicating the position of the material; and other information. In the case that an error has occurred, the operation completion report will include information indicating that processing of the sequence control commands has not ended normally; the manner in which the operation and processing were (virtually) carried out in terms of processing start time and error occurrence time; the state of the material as a result of the processing; error type and details; and other information. Information (accessory information) indicating the state of the material as a result of the control operation is material-level information, and the execution results are transferred from the simulation processing unit 22 of the equipment simulator 2 to the equipment controller 3.

The operation completion report related to the recipe control commands includes information (accessory information) indicating that processing of the recipe control commands has ended normally; the manner in which processing was (virtually) carried out in terms of processing start time, end time, and processing time; and the state (gas flow rate, temperature, power, and the like) of the equipment, modules, and components as a result of the processing. In the case that an error has occurred, the operation completion report will include information indicating that processing of the recipe control commands has not ended normally; the manner in which processing was (virtually) carried out in terms of processing start time and error occurrence time; the state (gas flow rate, temperature, power, and the like) of the equipment, modules, and components as a result of the processing; error type and details; and other information. Information (accessory information) indicating the state of the equipment, modules, and components as a result of the control operation is information for the equipment, module, and component levels (levels as the object of control commands), and the execution results are transferred from the simulation processing unit 22 of the equipment simulator 2 to the equipment controller 3.

In S220, the sequence control commands among the control commands received from the equipment controller 3 are often control commands to the I/O device level to elevate and lower a lifter. However, there are some control commands for the levels higher than the I/O device level, i.e., the equipment layer, the module layer, and the subsystem layer. In such cases as well (cases in which the control commands are not directed to the I/O device level), a program in the simulation processing unit 22 is started in relation to the level of the control commands in similar fashion to the case in which control commands are made to the I/O device level, and the processing is executed based on the program in accordance with the control commands. In other words, operation of the level of the virtual processing equipment is started (S280) in response to the control commands. The intended level of a control command can be determined by including information that can identify the intended level of a control command in accessory information that accompanies the control command. The control commands and accessory information differ in each level, and the target level may be determined depending on the type of control command and the accessory information.

The processing carried out by the program of the target level, whereby the operation of the target level is virtually started and the timer (not shown) stored in the simulation processing unit 22 therefore starts timer operation.

When the processing of the control commands has ended or when a predetermined processing time has elapsed (S290), the processing of the program of the level is ended. In other words, operation and processing of the level is virtually ended, and the timer operation of the timer is ended (S300).

Among the equipment level, the module level, and subsystem level, the simulation processing unit 22 transfers (S310) the execution results to the equipment controller 3 in the form of an operation completion report after the virtual operation and processing in the corresponding level has ended. The operation completion report, which is the transferred execution results, includes information (accessory information) indicating that processing of the control commands has ended normally in the same manner as the I/O device level; the manner in which the operation and processing were (virtually) carried out in terms of processing start time, end time, and processing time; and the state of the material, and the equipment, modules, and components as a result of the processing. Information indicating the state of the material, and the equipment, modules, and components as a result of the control operation is information (accessory information) in the target levels, respectively, and the execution results are transferred from the simulation processing unit 22 of the equipment simulator 2 to the equipment controller 3.

As described above, when sequence control commands and recipe control commands are received from the equipment controller 3 in the simulation processing unit 22, the program of the level that corresponds to the control command is virtually executed in a sequential manner in accordance with the control commands, and the execution results are returned to the equipment controller 3 in the form of an operation completion report. While the processing shown in FIG. 12 is under control of the equipment controller 3, the simulation processing unit 22 repeats the above process, and the display processing unit 23 displays the processing that corresponds to the simulation on the display equipment 32 of the equipment simulator 2 or on a predetermined computer terminal.

The execution results in the simulation processing unit 22 of the equipment simulator 2 are reflected in the equipment controller 3 and are therefore acquired by the EES 4 as detailed equipment event data, or trace data and context data that corresponds thereto (S130). The software or the like can be suitably edited by referring to the acquired execution results.

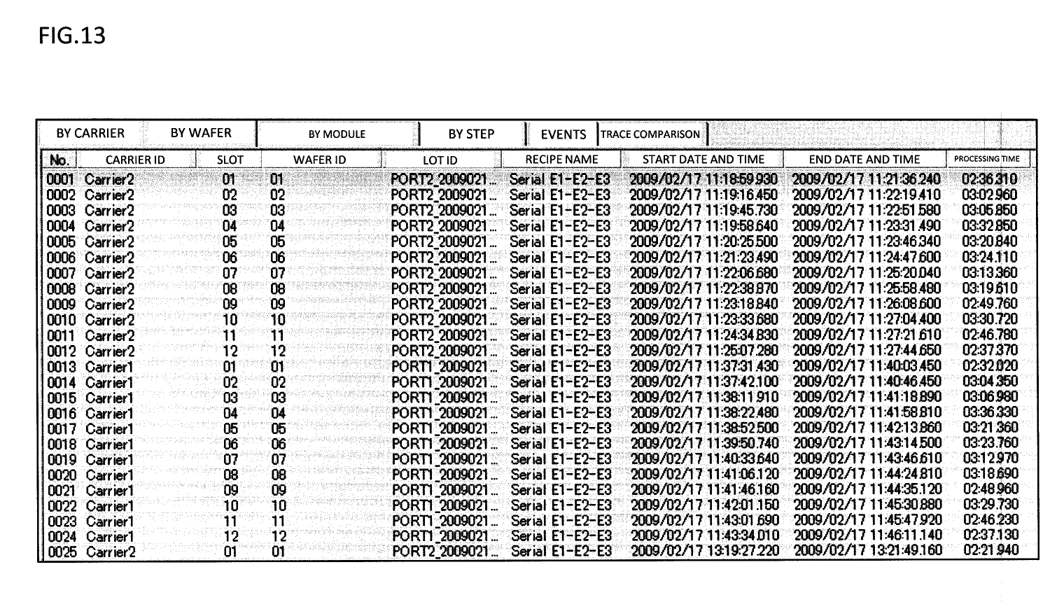

FIG. 13 schematically shows an example of a wafer processing list used for processing in an equipment simulator 2. In FIG. 13, the processing time and the timestamp indicating the processing start and end times of each wafer are displayed in a list. Since the simulation is carried out using as the setting value the time for the equipment to operate prior to completing the processing equipment, tuning can be carried out by modifying the setting value even before processing equipment has been completed. FIG. 13 is an example of a display of the detailed equipment event data in relation to the sequence control commands, but the detailed equipment event data related to the recipe control commands may also be similarly displayed.

In this manner, in the recipe management system 11 in the equipment parameter setting support system 1, the execution results (detailed equipment event data, and trace data and context data corresponding thereto) of the recipe data stored in the equipment controller 3 can be acquired by executing simulation processing in the equipment simulator 2 in the manner described above without operating the real equipment 6.

The execution results (detailed equipment event data, and trace data and context data corresponding thereto) are received in the recipe management system 11 and are displayed as a graph (FIG. 8). The engineer checks the graph and suitably re-edits the values (target values) of the recipe data from the recipe management system 11, and saves the data as new recipe data by sending the data from the recipe management system 11 to the equipment controller 3. Simulation processing is executed again in the equipment simulator 2 on the basis of the new recipe data in the equipment controller 3, and the engineer checks the execution results of the new recipe data.

By repeating the work described above the engineer can improve the precision of the recipe data values (target values) without operating the real equipment 6.

In the case that the engineer has obtained the desired recipe data precision, the real equipment 6 is operated in order to ultimately confirm the recipe data. In other words, the equipment controller 3 is switched to the real control mode (the mode may be switched manually or automatically; alternatively, a confirmation message about switching the mode may be displayed and the switch made when the user provides permission by input) and the sequence control commands and the recipe control commands are transferred to the real equipment 6, which is a real machine. The EES 4 acquires the control commands transferred at this time as the detailed equipment event data. The real equipment 6 as a real machine is operated in accordance with the control commands.

The execution results are reflected in the equipment controller 3 in the same manner as the simulation and are therefore acquired by the EES 4 as detailed equipment event data (S140).

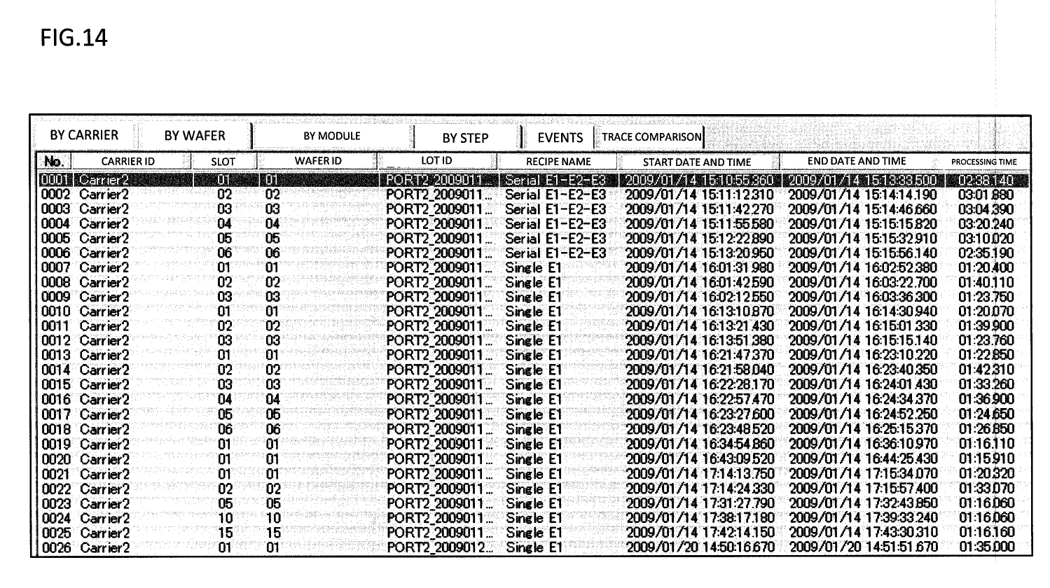

FIG. 14 schematically shows an example of a wafer processing list used for processing in the real equipment 6. In FIG. 14, the processing time and the timestamp indicating the processing start and end times of each wafer are displayed in a list.

The equipment controller 3 transfers essentially the same control commands in the simulation mode and in the real control mode. Therefore, since the execution results in the simulation mode and the execution results in the real control mode are acquired in the EES 4, the results can be displayed on the same screen, for example, whereby the simulation mode and the real control mode can be readily compared.

For example, the processing performance of the equipment simulator 2 (simulation mode) operating with the design values and the real equipment 6 (real control mode) as a real machine can be compared by listing, and the operation and processing conditions of the real equipment 6 can be adjusted (S150). In other words, the development staff can verify the execution results by comparatively displaying the execution results of the simulation mode and the real control mode. Also, the new operating parameters (e.g., operating time, and the like) reflecting the verification results can be read into the modeling layout unit 20 of the equipment simulator 2 and thereby verified in the simulation mode.

Instead of acquiring the execution results of the simulation mode and the real control mode in the EES 4 and making a comparison, the execution results of the simulation mode can be displayed on the display equipment 32 of the equipment simulator 2 or the like and the equipment simulator 2 can receive the edited input (input of new operating parameters) of the operating parameters in the equipment layout data on the basis of the results, whereby simulation processing can be carried out again in the simulation processing unit 22.

When a malfunction has occurred in the operation of the real equipment 6 used as the real machine, the operating parameters are set based on the detailed equipment event data (control information that includes control commands and execution results, or accessory information included therein) stored in the EES 4 (the detailed equipment event data is acquired via a network or storage equipment 31), and simulation processing is carried out in the simulation processing unit 22 of the equipment simulator 2, whereby operation of the real equipment 6 as the real machine can be confirmed without the need for development staff to visit the installation site.

In FIGS. 13 and 14, the processing time and the timestamp indicating the processing start and end times of each wafer are displayed in a list, but it is also possible to display in the same table a graph of the execution results obtained of the recipe control commands and a Gantt chart of the execution results of the sequence control commands, as shown in FIG. 8, for example. The state the components of the equipment and the processing state at that time can thereby be confirmed by comparison.

### Example 2

Described next is the case in which simulation processing is carried out using various data (detailed equipment event data, trace data, context data, and the like) as the operating parameters stored in the EES 4. In other words, the case of visually reproducing (simulating) the various operation logs of the real equipment 6 will be described.

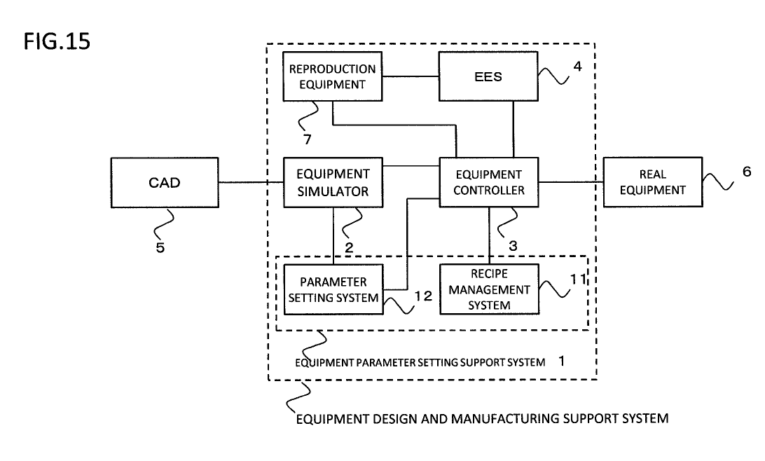

The equipment design and manufacturing support system is furthermore provided with reproduction equipment 7 for carrying out simulation processing. FIG. 15 schematically shows the equipment design and manufacturing support system of the present example.

The reproduction equipment 7 is equipment for reading the control commands and the execution results in relation thereto; i.e., the detailed equipment event data, trace data, context data and other data, and carrying out simulation processing on the basis of these data. A computer terminal may be used as the reproduction equipment 7, but no limitation is imposed thereby; any means may be used. The simulation processing is carried out in the same manner as the processing in the simulation processing unit 22 of the equipment simulator 2. In other words, the equipment layout data stored in advance in the reproduction equipment 7, and a simulation program stored in each level of an object to be controlled that has been hierarchized into the same level as a real equipment 6, are stored in the same manner as with the simulation processing unit 22; and the simulation processing is carried out in the same manner as the simulation processing unit 22 on the basis of equipment layout data and the simulation program. However, the reproduction equipment 7 does not receive control commands from the equipment controller 3, but rather carries out simulation processing on the basis of the execution results and the control commands that have been read. The control commands and execution results (detailed equipment event data, trace data, context data, and the like) may be read by the reproduction equipment 7 as data stored in a CD-ROM, semiconductor memory, or other recording media, and the data stored in the EES 4 or the like of the real equipment 6 may be acquired and read by the reproduction equipment 7 via a network.

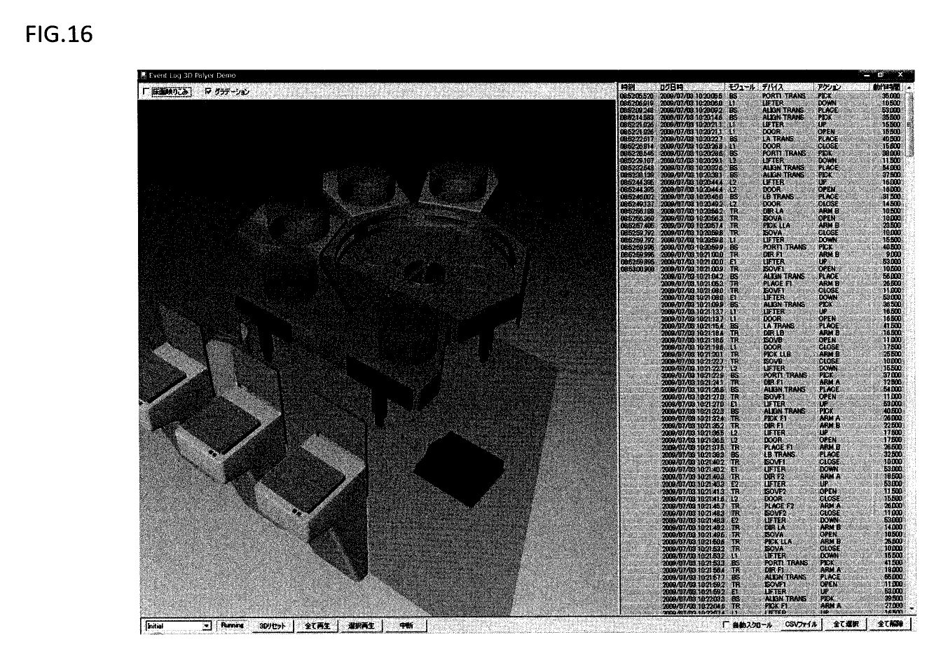

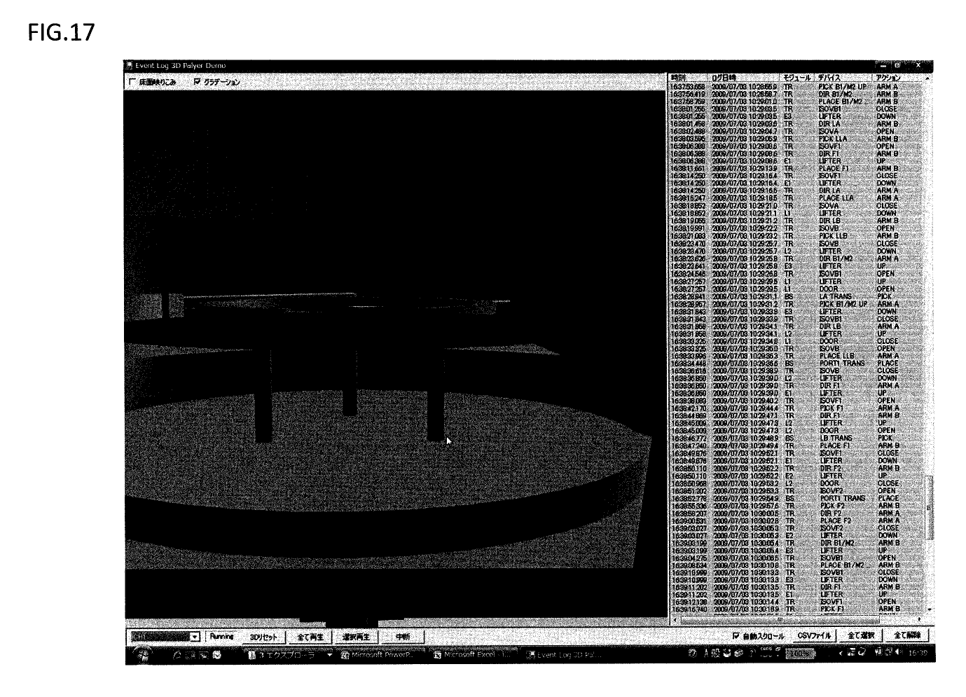

FIG. 16 is an example of a screen showing the state of simulation processing displayed by the reproduction equipment 7. The simulation processing is shown on the left side of the screen, and detailed equipment event data (or trace data and context data that corresponds thereto) is shown on the right side.

In the case that the simulation processing is shown by the reproduction equipment 7, the execution results of the simulation processing may be displayed from the material viewpoint.

Simulation processing from the viewpoint of the material does not only refer to mere 2D or 3D display of the state of the simulation processing on the basis of the execution results, but also refers to 2D or 3D display by the reproduction equipment 7 from the location in which the material is positioned. In other words, when simulation processing is carried out in a simple manner, the execution results are merely displayed in an overview perspective in 2d or 3D display (FIG. 16 and the like). Therefore, the overall simulation can be confirmed, but the state of the material as the processing target cannot be constantly confirmed. The display of the material can alternatively be enlarged, but it is necessary to provide instructions for showing an enlarged display of the location where the material is likely be positioned, and the location where the material is positioned must be shown in an enlarged display each time the material has moved.

However, the state of the simulation processing can be displayed in 2D or 3D from the perspective of the location in which the material is positioned by carrying out simulation processing in the present example from the perspective of the material. The perspective position is automatically changed in accompaniment with the movement of the material, and the state as seen from the material can be reproduced.

For example, in the case that the material is a wafer, the position in which the wafer is located can be displayed as the perspective.

FIG. 17 shows an example of a screen showing simulation processing from the perspective of the material. The state of simulation processing is shown from the material perspective on the left side of the screen, and detailed equipment event data (or trace data and context data that corresponds thereto) are shown on the right side.

The display showing the state of simulation processing from the material perspective is carried out by specifying the position of the material on the basis of the accessory information in the execution results of the detailed equipment event data, and then displaying the position as the perspective at any angle or direction. In other words, position information (location information) is included in the information showing the state of the material in the accessory information of the execution results, and the reproduction equipment 7 calculates the equipment display in 2D or 3D for any direction or angle and displays the result from the perspective indicated in the position information.

In the reproduction equipment 7, the interval between two events specified by the user can be reproduced on the basis of the detailed equipment event data that has been read. In other words, the operation of the equipment is reproduced using the detailed equipment event data, and at the same time the trace data and context data currently being processed can be displayed in a graph or as data.

In other words, the reproduction equipment 7 virtually reproduces control that corresponds to the control commands, and displays the execution results that are based on the detailed equipment event data, as well as the trace data and context data correlated therewith. In this case, the material perspective can be displayed by determining the processing that the material undergoing and the location of the material in the processing equipment.

The reproduction equipment 7 carries out the simulation processing having reflected the processing time in the detailed equipment event data when the simulation processing is carried out from the material perspective in the reproduction equipment 7. Specifically, the processing time is stored as five seconds (or the difference between the processing start time and the processing end time is five seconds) in the detailed equipment event data in the case that a certain processing required five seconds. Therefore, the simulation is carried out reflecting the actual time required for the processing. For example, the reproduction equipment 7 uses a timer (not shown) in the reproduction equipment 7 and carries out simulation processing on the basis of the processing time (or the difference between the processing start time and the processing end time) in the detailed equipment event data so that the processing time is the same.

The processing may be carried out at the same speed, double speed, triple speed, or half speed, one-third speed, or the like, and the simulation processing can be configured to be carried out in accordance with a predetermined time factor.

In the reproduction equipment 7, when there is information indicating that there is an error in the detailed equipment event data, trace data, or context data, the state before and after the error can be reproduced in the reproduction equipment 7 from the material perspective on the basis of the time before and/or after the occurrence of the error and the detailed equipment event data, trace data, and context data.

Furthermore, when reproduction is carried out in the reproduction equipment 7 in accordance with the detailed equipment event data, trace data, and context data described above, the state of the processing equipment, the constituent components thereof, and temperature and pressure of the material can be visually displayed by referencing the trace data that corresponds to the detailed equipment event data. In other words, the detailed equipment event data contains information about the time at which events take place. Therefore, reproduction can be carried out by referencing the trace data and reproducing the equipment, the constituent components thereof, and the temperature and pressure of the material using colors, characters, sounds, and the like because the corresponding trace data can be identified based on the time information (the trace data is temporal change information and therefore includes time information). For example, in the case that the temperature change of the material is displayed using colors, the trace data specified based on the detailed equipment event data is referenced, and the material is displayed in a predetermined color that corresponds to the temperature in accordance with the temporal change. The color of the material is varied and displayed in different colors (or color densities) in the case that the temperature of the material has exceeded a predetermined threshold.

The processing described above makes it possible for the reproduction equipment 7 to not only merely display the material perspective, but also display the pressure and temperature of the material or the like in an understandable manner.

In addition to the material, it is possible to use a configuration in which the pressure and temperature of the components (I/O devices and the like) constituting the equipment are also displayed on the basis of the trace data as execution results of the recipe control commands. For example, it is also possible to use a configuration in which the pressure and temperature (pressure, temperature, and the like inside the equipment) are displayed as the process power, gas flow rate, gas pressure, and environment data of the I/O device.

In the additional case that information is included in the detailed equipment event data, trace data, and context data that indicates an error has occurred, the reproduction equipment 7 specifies the components in which the error occurred based on the detailed equipment event data, trace data, and context data, and displays the component in a different color that is normally used (e.g., a color indicating that an error has occurred), whereby the component of the error indicated in the detailed equipment event data, trace data, and context data can be identified.

Described in the present example is the case in which simulation processing is carried out by the reproduction equipment 7 from the material perspective, but it is also possible to use a configuration in which the simulation processing is carried out from the same material perspective as the present example using the simulation processing unit 22 of the equipment simulator 2.

The detailed equipment event data, trace data, context data, and the like used for simulation processing in the reproduction equipment 7 are not limited to being data acquired by the EES 4. In other words, the data may be log data acquired from the equipment controller 3, the EES 4, or the like having a completely different data format. In view of the above, a conversion table is stored in the reproduction equipment 7 or the EES 4 in order to convert among the data formats of the log data, and the detailed equipment event data, trace data, context data, and various other data in the case that simulation processing will be carried out in the reproduction equipment 7 using log data from the equipment controller 3 or the EES 4 in a completely different data format. The log data is converted to the data format of the detailed equipment event data, trace data, context data, and the like on the basis of the conversion table, and the reproduction equipment 7 carries out simulation processing from the material perspective on the basis of the data obtained by data format conversion. Therefore, simulation processing can be carried out from the material perspective even with log data produced by equipment that does not included the equipment controller 3 or EES 4 or the equipment design and manufacturing support system of the present example.

Recipe information managed and edited in the recipe management system 11 of the equipment parameter setting support system 1 of the present invention can be suitably set using the a method such as that described above. As a result, simulation processing can be carried out to predict equipment throughput and other equipment performance while minimally operating the real equipment 6 by using the equipment design and manufacturing support system.

### Example 3

Described next is the processing for setting PID parameters using the PID control scheme of the equipment simulator 2 and the real equipment 6 using the parameter setting system 12 of the equipment parameter setting support system 1 of the present invention.

When the real equipment 6 is moved over a certain interval, the equipment performance (e.g., throughput) gradually degrades from an ideal state due to degradation of the components of the equipment, the accumulation of unwanted matter, and other causes. When daily changes accumulate over time, the difference between the actual equipment performance (e.g., throughput) and the equipment performance (e.g., throughput) in an ideal state becomes considerable over time. The real equipment 6 can be returned to its original ideal state by performing maintenance, and the equipment performance (e.g., throughput) can be restored.

However, it is not practical to constantly perform maintenance, and maintenance can only be performed periodically (e.g., three months). On the other hand, degradation, accumulation of unwanted matter, and other such adverse events do not occur in the equipment simulator 2. Accordingly, considerable difference occurs between the equipment performance (e.g., throughput) in the equipment simulator 2 and the equipment performance (e.g., throughput) in the real equipment 6.

In view of this situation, in order to correct changes in the equipment performance (e.g., throughput), the parameter setting system 12 establishes the settings in accordance with the equipment performance of the real equipment 6 by modifying the PID parameters used in PID control and stored in the simulation processing unit 22. The initial values (ideal state) of the PID parameters can be set by using a conventional method for setting PID parameters.

Next, an example of the processing of the parameter setting system 12 will be described with reference to the flowchart in FIG. 19.

First, the execution results acquisition unit 121 of the parameter setting system 12 acquires the detailed equipment event data (or trace data and context data that corresponds thereto) of any two points in time (preferably the initial values (ideal state) and just prior to maintenance) from the EES 4 or the equipment controller 3 (S400).

The parameter calculation unit 122 of the parameter setting system 12 calculates the PID parameters at each time point on the basis of the detailed equipment event data (or trace data and context data that corresponds thereto) acquired in the execution results acquisition unit 121 (S410). A conventional method may used for calculating the PID parameters.

After the PID parameters have been calculated at the two points in time, the difference calculation unit 123 of the parameter setting system 12 calculates (S420) the difference between the PID parameters at the two points in time used for calculation in the parameter calculation unit 122. The variation value calculation unit 124 of the parameter setting system 12 calculates the variation value (differential value) of the PID parameters for each unit interval by dividing the difference calculated in the difference calculation unit 123 by the unit interval (S430). Therefore, the variation value of the difference per unit interval can be calculated daily, or weekly, for example. The unit interval is an interval with an arbitrarily set unit when the interval between two points in time is to be divided, and examples of this arbitrarily set interval include one day, two days, three days, one week, two weeks, and one month.

The data transmission unit 125 of the parameter setting system 12 sends the variation value of each unit interval to the equipment simulator 2 on the basis of the variation value of the difference between the unit interval calculated in the manner described above, incorporates (e.g., performs addition, subtraction, and other computations) and stores the variation value in the PID parameters stored in the equipment simulator 2, and carries out processing for reflecting the changes in the equipment state and the changes over time in the real equipment 6 (S440). The variation value of the PID parameters is sent by the parameter setting system 12 to the equipment simulator 2 at each unit interval and is incorporated by computation with the PID parameters stored in the equipment simulator 2, whereby the PID parameters can be updated as new PID parameters. It is also possible to send the variation value for each unit interval in advance to the equipment simulator 2, whereby the equipment simulator 2 can automatically compute the variation value for each unit interval and update the PID parameters as new PID parameters.

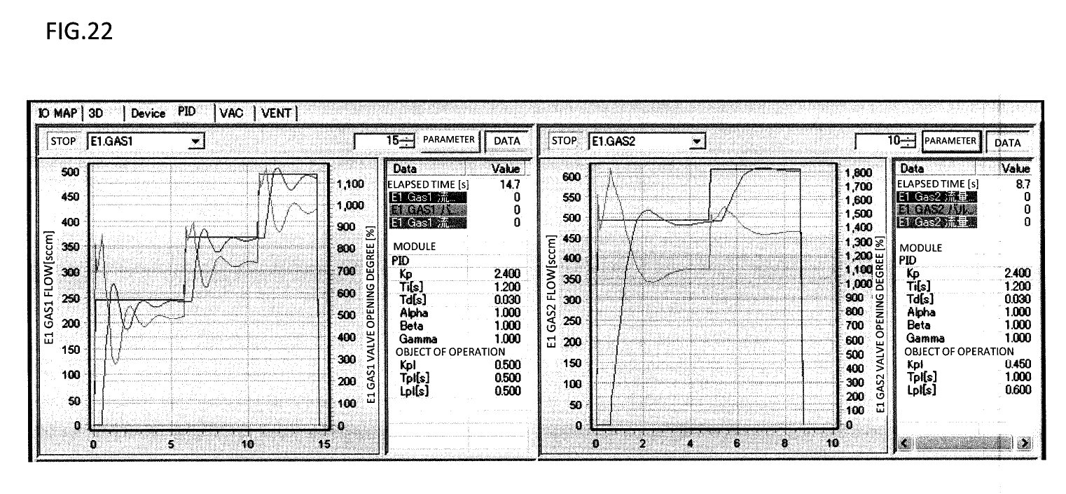

FIG. 22 schematically shows an example (PID parameters and graph of the execution results in relation to a certain recipe control command) of a screen in the case that the PID parameters are calculated at two points in time in the parameter setting system 12.

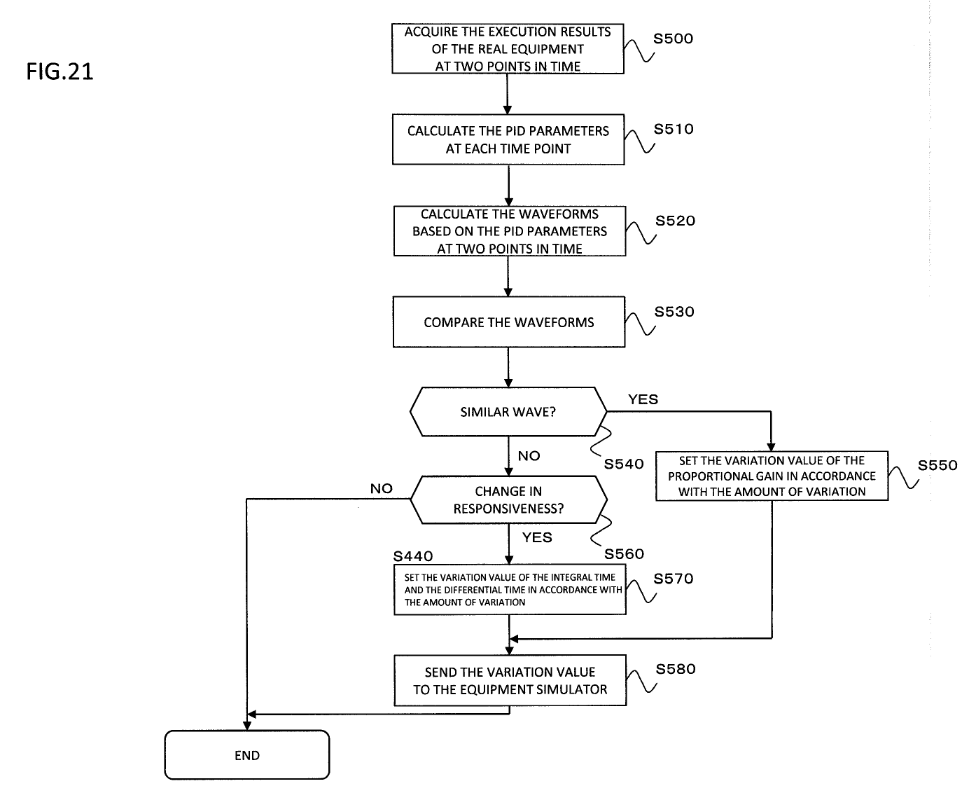

In addition to using the difference in parameters at two points in time, it is also possible to set (calculate the variation value) the PID parameters by comparing and determining the waveforms of the PID parameters at two points in time as described above. An example of the processing of the parameter setting system 12 in this case will be described with reference to the flowchart of FIG. 21.

First, the execution results acquisition unit 121 of the parameter setting system 12 acquires the detailed equipment event data (or trace data and context data that corresponds thereto) of any two points in time (preferably the initial values (ideal state) and just prior to maintenance) from the EES 4 or the equipment controller 3 in the same manner as described above (S500).

As described above, the parameter calculation unit 122 of the parameter setting system 12 calculates the PID parameters at each time point on the basis of the detailed equipment event data (or trace data and context data that corresponds thereto) acquired in the execution results acquisition unit 121 (S510). A conventional method may used for calculating the PID parameters.

After the PID parameters have been calculated at the two points in time, the waveform calculation unit 126 of the parameter setting system 12 calculates the difference between the PID parameters at the two points in time (S520). FIG. 9 shows an example of a PID waveform.

The waveform comparison unit 127 compares the PID waveforms at each time point on the basis of the PID waveforms at each time point calculated in this manner, and determines if the waveforms are similar and if there is a difference in responsiveness (S530).

In the case that the waveform comparison unit 127 compares and determines whether there is similarity (S540), the variation value calculation unit 124 computes the percentage of similarity. The variation value of the PID parameters (proportional gain Kp in particular) is calculated in accordance with the calculated percentage of similarity (S550).

In the case that, among the PID waveforms as the objects of comparison, a PID waveform becomes larger at a later time point, the proportional gain Kp is reduced in accordance with the calculated percentage. On the other hand, among the PID waveforms as the objects of comparison, when a PID waveform becomes smaller at a later time point, the proportional gain Kp is increased in accordance with the calculated percentage.

For example, when the responsiveness of a PID waveform at a later time point has changed, the difference X in the proportional gains Kp is calculated for two points in time. The variation value of the proportional gain Kp is calculated to be X/90 in the case that the interval of the two points in time is 90 days and the unit interval is a single day.

In other words, when the calculated variation value is sent to the equipment simulator 2 (S580), the proportional gain Kp among the PID parameters is varied (addition, subtraction, multiplication, division, or another predetermined computation) and adjusted in increments of X/90 per day, and the PID parameters are updated.

When the waveform comparison unit 127 compares and determines that there is a change in responsiveness (S560), the percentage that the responsiveness has increase or decrease is calculated. The variation value of the PID parameters (integral time Ti and differential time Td in particular) is calculated in accordance with the calculated percentage (S570).

In the case that, among the PID waveforms as the objects of comparison, the responsiveness of the PID waveform has increased at a later time point, the integral time Ti is increased in accordance with the calculated percentage. Also, the differential time Td is reduced in accordance with the calculated percentage.

For example, when the responsiveness of the PID waveform has changed at a later time point, the difference Y in the integral time Ti and the difference Z in differential time Td at two points in time are calculated. In the case that the interval between the two points in time is 90 days and the unit interval is a single day, calculations are made using Y/90 as the variation value of the integral time Ti and Z/90 as the variation value of the differential time Td.

In other words, when the calculated variation value is sent to the equipment simulator 2 (S580), the integral time Ti among the PID parameters is varied (addition, subtraction, multiplication, division, or another predetermined computation is performed) and adjusted in increments of Y/90 per day, the differential time Td is varied (addition, subtraction, multiplication, division, or another predetermined computation is performed) and adjusted in increments of Z/90 per day, and the PID parameters are updated.

The data transmission unit 125 of the parameter setting system 12 sends the variation value of each unit interval to the equipment simulator 2 on the basis of the variation value of the difference between the unit interval calculated in the manner described above, incorporates (e.g., performs addition, subtraction, and other computations) and stores the variation value in the PID parameters stored in the equipment simulator 2, and carries out processing for reflecting the changes in the equipment state and the changes over time in the real equipment 6. The variation value of the PID parameters is sent by the parameter setting system 12 to the equipment simulator 2 at each unit interval and new PID parameters can be updated by computation with the PID parameters stored in the equipment simulator 2. It is also possible to send the variation value for each unit interval in advance to the equipment simulator 2, whereby the equipment simulator 2 can automatically compute the variation value for each unit interval and update the PID parameters as new PID parameters.

The PID parameters in which changes in the equipment state and changes over time have been reflected can be set in the equipment simulator 2 by setting the PID parameters in the manner described above.

### Example 4

The parameter setting system 12 may also carry out processing that incorporates changes in the equipment state and change over time in equipment, modules, and components in which PID control is not used. For example, when the vacuum exhaust time in vacuum equipment, event time, and the like are simulated in the simulation processing unit 22, the simulation processing may be carried out with consideration given to changes in the equipment state and change over time in relation to the above-noted variables.

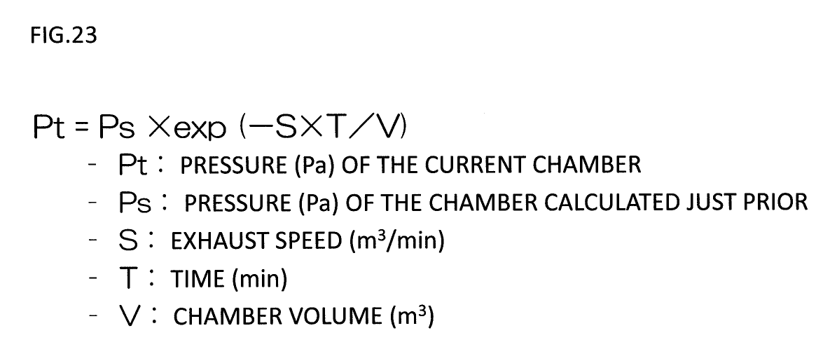

The vacuum exhaust time in an ideal state can be calculated in the vacuum equipment using the formula shown in FIG. 23. The simulation processing of the vacuum equipment is carried out using the resulting value. However, the vacuum equipment also varies from an ideal state due to degradation and the like of pumps and valves.

Accordingly, after the parameters at two points in time have been calculated in the same manner as Example 3 described above, the difference in the parameters is divided by the elapsed time from a reference time point to calculate the variation value (differential) of the difference in the parameters for each predetermined interval.

The calculated difference in parameters is divided by the interval between the two points. The variation value of the difference per unit interval can thereby be calculated, e.g., daily, or weekly. The unit interval is an interval with an arbitrarily set unit when the interval between two points in time is to be divided, and examples of this arbitrarily set interval include one day, two days, three days, one week, two weeks, and one month.

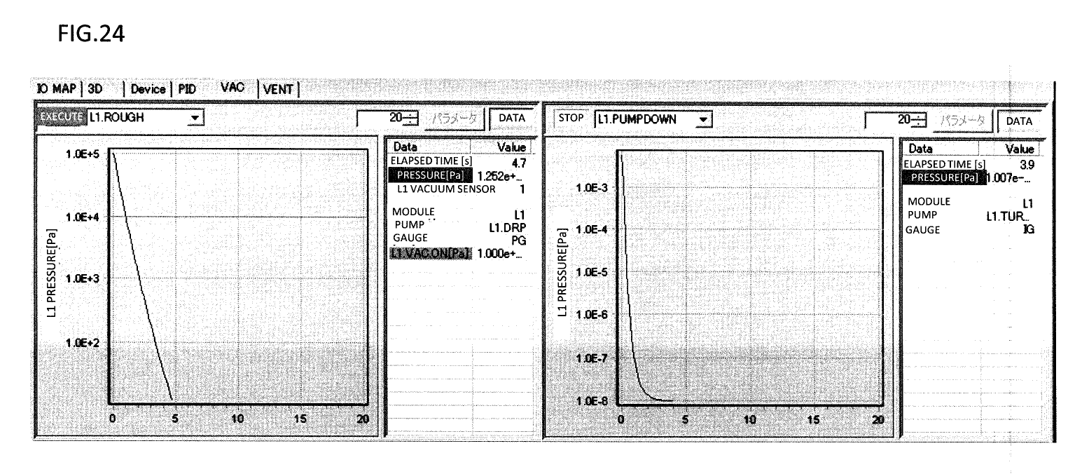

FIG. 24 schematically shows an example (parameters and graph of the execution results in relation to a certain recipe control command) of a screen in the case that the parameters are calculated at two points in time of the vacuum equipment in the parameter setting system 12.

The parameter setting system 12 incorporates (e.g., performs addition, subtraction, and other computations) and stores the variation value in the PID parameters of the vacuum equipment stored in the equipment simulator 2 for each unit interval on the basis of the variation value of the difference between the unit interval calculated in the manner described above, and carries out processing for reflecting the changes in the equipment state and the changes over time in the real equipment 6. The variation value of the PID parameters is sent by the parameter setting system 12 to the equipment simulator 2 at each unit interval and new parameters can be updated by computation with the parameters stored in the equipment simulator 2. It is also possible to send the variation value for each unit interval in advance to the equipment simulator 2, whereby the equipment simulator 2 can automatically compute the variation value for each unit interval and update the parameters as new parameters.

### Example 5

In the examples described above, suitable PID parameters are set by simulating PID control. However, the behavior of a program during equipment trouble can be verified by setting the PID parameters in the parameter setting system 12 so that an error will intentionally occur and then transferring the PID parameters to the equipment simulator 2.

In other words, the parameter setting system 12 receives input of abnormal values which have been inputted by an equipment engineer or the like as the parameters (PID parameters or the like) to be used in the simulation processing in the equipment simulator 2 and in which an error will occur in the simulation processing of the equipment simulator 2.

When the parameter setting system 12 receives input of parameters in this manner, the parameters having the abnormal values are transferred to the equipment simulator 2 (in this case, the transfer may be made via another equipment rather than directly to the equipment simulator 2). In the equipment simulator 2, the abnormal values for generating an abnormal state are set and stored as parameters for simulation processing.

The equipment simulator 2 carries out simulation processing on the basis of the parameters set in the manner described above when the simulation processing is to be carried out. Accordingly, equipment trouble and other error states are displayed as a simulation by carrying out simulation processing. The equipment engineer confirms the status, whereby equipment trouble or the like can be ascertained without operating the real equipment 6.

In this manner, abnormal states can be verified without damaging, breaking, or destroying the real equipment 6 by simulating equipment trouble.

### INDUSTRIAL APPLICABILITY

Differences in the equipment performance between the real equipment 6 and the equipment simulator 2 can be reduced to the extent possible by using the equipment parameter setting support system 1 described above, even when changes in the equipment state and change over time have occurred in the equipment. Also, when the recipe is to be set, a suitable recipe setting can be made without using actual processing equipment to the extent possible.

1. An equipment parameter setting support system used in an equipment design and manufacturing support system for supporting the design and manufacture of processing equipment, said equipment parameter setting support system characterized in comprising:
an execution results acquisition unit for acquiring, from an equipment controller or EES of said equipment design and manufacturing support system, execution results of a real equipment at any two points in time;
a parameter calculation unit for calculating PID parameters at each point in time on the basis of said acquired execution results;
a difference calculation unit for calculating the difference between the calculated PID parameters; and
a variation value calculation unit for calculating a variation value for a unit interval in relation to the calculated difference, wherein
in said equipment design and manufacturing support system, said calculated variation value and PID parameters stored in said equipment simulator are computed to calculate a new PID parameter, and PID control is executed in the equipment simulator using the new PID parameter.

2. An equipment parameter setting support system used in an equipment design and manufacturing support system for supporting the design and manufacture of processing equipment, said equipment parameter setting support system characterized in comprising:
an execution results acquisition unit for acquiring, from an equipment controller or EES of said equipment design and manufacturing support system, execution results of a real equipment at any two points in time;
a parameter calculation unit for calculating PID parameters at each time point on the basis of said acquired execution results;
a waveform calculation unit for calculating a PID waveform on the basis of the calculated PID parameters;
a waveform comparison unit for comparing said calculated PID waveforms; and
a variation value calculation unit for calculating a variation value for a unit interval in relation to the variation value at said two points in time in the case that the results of said comparisons satisfy a predetermined condition, wherein
in said equipment design and manufacturing support system, said calculated variation value and PID parameters stored in said equipment simulator are computed to calculate a new PID parameter, and PID control is executed in the equipment simulator using the new PID parameter.

3. The equipment parameter setting support system according to claim 1 or 2, wherein
said data transmission unit presents the variation value of said calculated PID parameters to said equipment simulator at each arrival of said unit interval; and
said equipment design and manufacturing support system causes said variation value to be computed with the PID parameters stored in said equipment simulator to calculate a
new PID parameter, and causes PID control to be executed in the equipment simulator using the new PID parameter.

4. The equipment parameter setting support system according to claim 1 or 2, wherein
said data transmission unit presents the variation value of said calculated PID parameters to said equipment simulator; and
said equipment design and manufacturing support system causes said variation value to be computed with the PID parameters stored in said equipment simulator at each arrival of said unit interval to calculate a new PID parameter, and causes PID control to be executed in the equipment simulator using the new PID parameter.

5. The equipment parameter setting support system according to claim 1 or 2, wherein
said parameter setting system receives input of the PID parameters for simulating an error in said equipment simulator, and presents to said equipment simulator the PID parameters thus received as said input; and
said equipment simulator simulates equipment trouble by executing simulation processing on the basis of said PID parameter.

6. An equipment design and manufacturing support system for supporting design and manufacture of processing equipment,
said equipment design and manufacturing support system characterized in having an equipment simulator, an equipment controller, an EES, and a parameter setting system, wherein
said equipment simulator receives input of equipment layout data of real equipment, and executes simulation processing using PID control as virtual processing equipment via a simulation program that corresponds to individual levels of said real equipment on the basis of said equipment layout data and a control command from said equipment controller;
said equipment controller presents to said real equipment and said equipment simulator a control command for controlling said real equipment and virtual processing equipment in said equipment simulator;
said EES acquires the execution results of simulation processing in the virtual processing equipment in said equipment simulator, and the execution results in said real equipment;
said parameter setting system acquires the execution results in said real equipment at two points in time, calculates the PID parameters to be used in said equipment simulator at each of the time points on the basis of the acquired execution results, and calculates a variation value per unit interval of said PID parameters using the calculated PID parameter; and
said equipment simulator updates said PID parameters on the basis of the variation value calculated in said parameter setting system.

7. An equipment design and manufacturing support system for supporting design and manufacture of processing equipment,
said equipment design and manufacturing support system characterized in comprising an equipment simulator, an equipment controller, an EES, and a parameter setting system, wherein
said equipment simulator receives input of equipment layout data of real equipment, and executes simulation processing using PID control as virtual processing equipment via a simulation program that corresponds to individual levels of said real equipment on the basis of said equipment layout data and a control command from said equipment controller;
said equipment controller presents to said real equipment and said equipment simulator a control command for controlling said real equipment and virtual processing equipment in said equipment simulator;
said EES acquires the execution results of simulation processing in the virtual processing equipment in said equipment simulator, and the execution results in said real equipment;
said parameter setting system acquires the execution results in said real equipment at two points in time, calculates the PID parameters to be used in said equipment simulator at each of the time points on the basis of the acquired execution results, calculates a PID waveform at each of the time points using the calculated PID parameter, and calculates a variation value for each unit interval by comparing the calculated PID waveforms; and
said equipment simulator updates said PID parameters on the basis of the variation value calculated in said parameter setting system.

8. The equipment design and manufacturing support system according to claim 6 or 7, wherein said equipment design and manufacturing support system further comprises reproduction equipment, wherein
said reproduction equipment executes simulation processing as virtual processing equipment via a simulation program that corresponds to individual levels of said real equipment on the basis of the control command in said real equipment and/or the execution results.

9. The equipment design and manufacturing support system, according to claim 8, wherein
position information of material to be processed by control command is included in said execution results; and
said reproduction equipment displays simulation processing from the viewpoint of the material on the basis of the position information of the material in said execution results.

10. A method for setting recipe data for an equipment parameter setting support system using an equipment design and manufacturing support system for supporting the design and manufacture of processing equipment, said method for setting recipe data using an equipment parameter setting support system wherein:
a recipe management system presents recipe data set in advance as initial values to an equipment controller of said equipment design and manufacturing support system;
said equipment controller presents a recipe control command to an equipment simulator of said equipment design and manufacturing support system on the basis of the data of said recipe;
said equipment simulator executes simulation processing on the basis of the data of said recipe and sends the execution result to said equipment controller or EES; and
said recipe management system displays the execution results stored in said equipment controller or EES and receives a re-input of said recipe data, and the received recipe data is transferred from the recipe management system to said equipment controller of said equipment design and manufacturing support system, whereby a recipe control command based on new recipe data is transferred to said equipment simulator.
